(19) United States
(12) Patent Application Publication
(10) Pub. No.: US 2017/0018042 A1
(43) Pub. Date: Jan. 19, 2017

(54) METHOD AND SYSTEM FOR ENHANCED SMART AUTOMATION MANAGEMENT FACILITATING SOCIAL COOKERY

(71) Applicants: PAVAN PUDIPEDDI, AUSTIN, TX (US); ANANDARAM KATRAGADDA, BANGALORE (IN); NAVEEN CHAVA, BANGALORE (IN)

(72) Inventors: PAVAN PUDIPEDDI, AUSTIN, TX (US); ANANDARAM KATRAGADDA, BANGALORE (IN); NAVEEN CHAVA, BANGALORE (IN)

(21) Appl. No.: 15/210,883

(22) Filed: Jul. 14, 2016

Related U.S. Application Data
(60) Provisional application No. 62/192,067, filed on Jul. 14, 2015.

(51) Int. Cl. G06Q 50/12; G06F 17/30; G06Q 30/02

(52) U.S. Cl. CPC G06Q 50/12; G06Q 30/0255; G06F 17/30867

(57) ABSTRACT

Embodiments of the present invention specifically relate to a method and system for facilitating enhancing smart automation management of a room. The method comprises at least one of remotely and closely (locally) creating a database of databases comprising at least one of data and information in connection with the room, users associated therewith and additional physical entities (assets) confined thereto, using a first and a second portable computing and communications device, at least one of remotely and closely inputting values, in the database of databases, corresponding to qualitative and quantitative parameters representing the attributes of the room, users associated therewith and additional physical entities (assets) confined thereto, using the first and second portable computing and communications devices, at least one of remotely and closely determining the presence, identities and locations of the room, users associated therewith and additional physical entities (assets) confined thereto, using the first and second portable computing and communications devices, at least one of remotely and closely accessing the at least one of data and information in connection with the room, users associated therewith and additional physical entities (assets) confined thereto and the database of databases therefor, using the first and second portable computing and communications devices, at least one of remotely and closely transmitting and receiving the at least one of data and information to and from the room, users associated therewith and additional physical entities (assets) confined thereto and the database of databases therefor, using the first and second portable computing and communications devices, at least one of remotely and closely processing the data and information using the first and second portable computing and communications devices, thereby facilitating at least one of identifying and defining a context, at least one of remotely and closely managing the room, users associated therewith and additional physical entities (assets) confined thereto and the database of databases therefor, using the first and second portable computing and communications devices, and recommending optimal room, user, inventory, culinary and recipe management techniques using the first and second portable computing and communications devices, thereby facilitating social cooking.

### BACKGROUND OF THE INVENTION

Field of the Invention

Embodiments of the present invention generally relate to smart automation management facilitating social cookery.

Description of the Related Art

There are numerous containers of various types configured to store all matter of substances. However, determining the amount of the substance stored in the container, which is often useful to know, may be difficult to ascertain. Containers that can self-report the amount of their contents could save significant amounts of manual measuring or guesswork. Additionally, many secondary applications may be available from having a system of containers that self-report the amounts of their contents. In a kitchen environment, knowing the amount of container contents, such as food, can facilitate more informed food consumption and food purchase decisions. In a household kitchen, particularly when children have access to the kitchen, it may be difficult to regulate or keep track of the removal of food substances from containers. In a commercial kitchen including multiple food preparers rapidly preparing dishes in a stressful environment, the task of tracking the amounts of food substances in numerous containers can be even more challenging. In a laboratory environment, chemicals, and the like, may require detailed usage tracking. For instance, the substances may be expensive or hazardous. Such usage tracking may require careful removal and measuring of the substance and a recordation of the amount removed in a logbook. In hospital, pharmaceutical and manufacturing environments and the like, there may also be a need to keep track of the amount of the substance. Without accurate inventory determinations, maintaining inventory levels may be an ad hoc process. In one approach, inventory trends may be learned over time. However, any identified trends may be upset by unexpected usage. Accordingly, a device to accurately report the amount of a substance stored in a container at any given time may be useful in an inventory system.

### SUMMARY OF THE INVENTION

Embodiments of the present invention specifically relate to a method and system for facilitating enhancing smart automation management of a room. The method comprises at least one of remotely and closely (locally) creating a database of databases comprising at least one of data and information in connection with the room, users associated therewith and additional physical entities (assets) confined thereto, using a first and a second portable computing and communications device, at least one of remotely and closely inputting values, in the database of databases, corresponding to qualitative and quantitative parameters representing the attributes of the room, users associated therewith and additional physical entities (assets) confined thereto, using the first and second portable computing and communications devices, at least one of remotely and closely determining the presence, identities and locations of the, users associated therewith and additional physical entities (assets) confined thereto, using the first and second portable computing and communications devices, at least one of remotely and closely accessing the at least one of data and information in connection with the room, users associated therewith and additional physical entities (assets) confined thereto and the database of databases therefor, using the first and second portable computing and communications devices, at least one of remotely and closely transmitting and receiving the at least one of data and information to and from the room, users associated therewith and additional physical entities (assets) confined thereto and the database of databases therefor, using the first and second portable computing and communications devices, at least one of remotely and closely processing the data and information using the first and second portable computing and communications devices, thereby facilitating at least one of identifying and defining a context, at least one of remotely and closely managing the room, users associated therewith and additional physical entities (assets) confined thereto and the database of databases therefor, using the first and second portable computing and communications devices, and recommending optimal room, user, inventory, culinary and recipe management techniques using the first and second portable computing and communications devices, thereby facilitating social cooking. These and other systems, processes, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE DRAWINGS

FIG. 1A depicts the system for facilitating enhancing smart automation management of kitchens, via deployment of at least one of smart objects, smart connected products, smart devices, smart meters, smart appliances, smart containers, smart portable computing and communications devices, smart wearable computing and communications devices, and combinations thereof, in smart residential buildings, in turn, belonging to a gated community thereof, according to one or more embodiments;

FIG. 1B depicts an exploded view of the smart HAN, of FIG. 1A, based on the client-server architecture, according to one or more embodiments;

FIG. 1C depicts an exploded block diagrammatic view of the smart device, according to one or more embodiments;

FIG. 2 depicts a block diagrammatic representation of the smart portable chargeable gastronorm containers 112, of FIGS. 1A-C, facilitating measuring levels of substances contained therein, according to one or more embodiments;

FIG. 3 depicts a pictorial representation of the smart portable chargeable gastronorm containers 112, of FIGS. 1A-C and 2 in use, according to one or more embodiments;

FIGS. 4A-B depict a flow diagram in connection with the method for facilitating enhancing smart automation management of a shared residential or commercial room, according to one or more embodiments; and

FIG. 5 depicts a computer system that may be a computing device and may be utilized in various embodiments of the present invention.

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

While the method and system for enhanced smart home automation management facilitating social cookery in a social cooking network is described herein by way of example for several embodiments and illustrative drawings, those skilled in the art will recognize that the method and system for enhanced smart home automation management facilitating social cookery in a social cooking network, is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and system for enhanced smart home automation management facilitating social cookery in a social cooking network defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

In some embodiments, methods and systems for facilitating enhancing smart automation management of shared residential, commercial, private and utility-cum-storage rooms in at least one of smart residential and commercial buildings, in turn, belonging to a gated community thereof are disclosed, in accordance with the principles of the present invention. Specifically, methods and systems for facilitating enhancing smart automation management of shared residential, commercial, private and utility-cum-storage rooms, via deployment of at least one of smart physical objects, smart connected products, smart devices, smart meters, smart appliances, smart containers, smart computing and communications devices, and combinations thereof, in at least one of smart residential and commercial buildings, in turn, belonging to a gated community thereof are disclosed, in accordance with the principles of the present invention. As used herein, the term “building automation” refers to the automatic centralized control of heating, ventilation and air conditioning, lighting and other systems of a building through a Building Management System (BMS) or Building Automation System (BAS). The objectives of building automation are improved occupant comfort, efficient operation of building systems, and reduction in energy consumption and operating costs. As used herein, the term “room automation” refers to a subset of building automation and with a similar purpose. Room automation is the consolidation of one or more systems under centralized control, though being confined to a single room. The most common example of room automation is corporate boardroom, presentation suites, and lecture halls, where the operation of the large number of devices that define the room function, such as videoconferencing equipment, video projectors, lighting control systems, public address systems etc., may render manual operation of the room very complex. As used herein the term, the “home automation’ refers to the residential extension of building automation. Home automation is automation of the home, housework or household activity. Home automation may include centralized control of lighting, HVAC (heating, ventilation and air conditioning), appliances, security locks of gates and doors and other systems, to provide improved convenience, comfort, energy efficiency and security. Home automation for the elderly and disabled can provide increased quality of life for persons, who might otherwise require caregivers or institutional care.

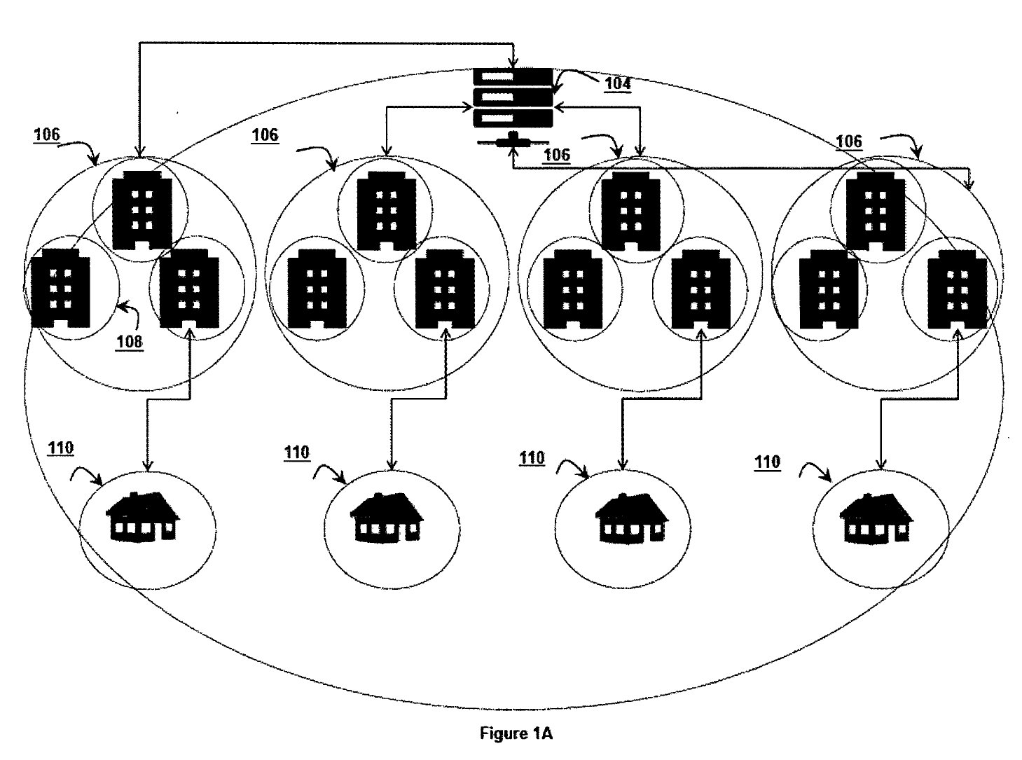

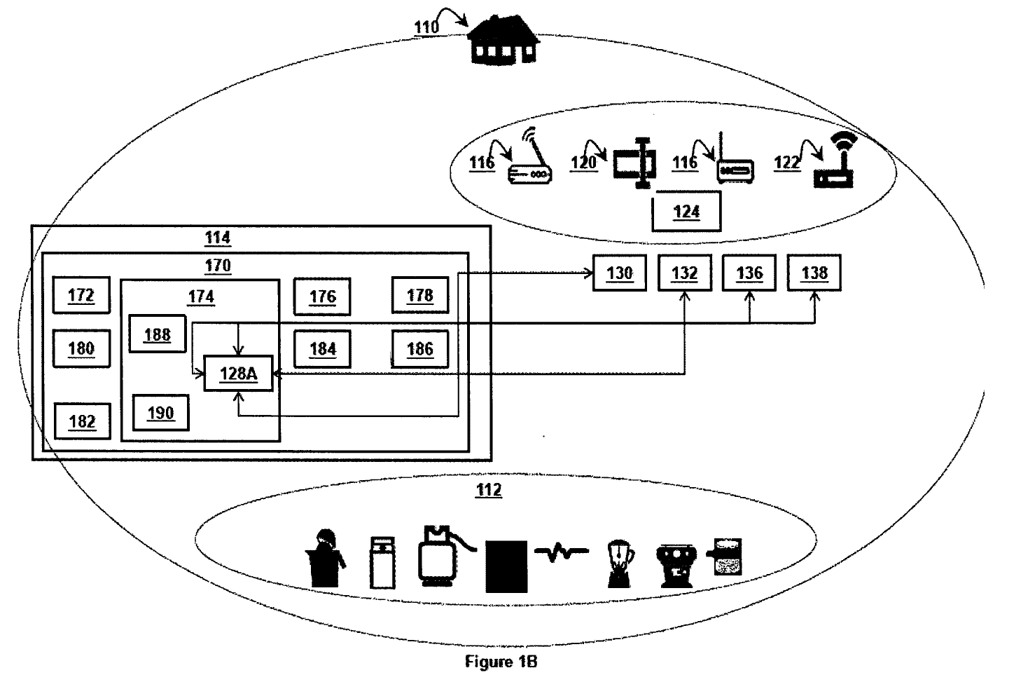

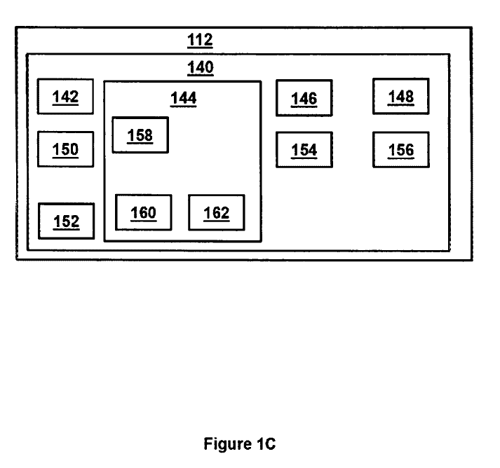

FIG. 1A depicts the system for facilitating enhancing smart automation management of kitchens, via deployment of at least one of smart objects, smart connected products, smart devices, smart meters, smart appliances, smart containers, smart portable computing and communications devices, smart wearable computing and communications devices, and combinations thereof, in smart residential buildings, in turn, belonging to a gated community thereof, according to one or more embodiments.

The system 100 may comprise a network subsystem 102. As depicted in FIG. 1A, in some embodiments, the network subsystem 102 may be symbolically analogous to a multi-level hierarchical rooted forest of networks, wherein each of the constituent networks may be symbolically analogous to a tree. The network subsystem 102 may comprise an optional centralized server 104 catering or serving to one or more Neighborhood Area Networks (or NANs) 106, wherein each of the NANs 106 may be correspondingly deployed in each of one or more gated communities. Optionally, each NAN 106 may be at least one of wiredly and wirelessly coupled to the centralized server 104. In turn, each NAN 106 may comprise one or more smart BANs 108 correspondingly deployed in each of one or more smart buildings. Further, in turn, each smart BAN 108 may comprise one or more smart HANs 110 correspondingly deployed in each of one or more smart homes. In some embodiments, each of the NANs 106, the corresponding smart BANs 108 and, in turn, the corresponding smart HANs 110 may be based on client-server architecture. Each NAN 106 may serve as a server network to each of the smart BANs 108 coupled thereto as a client network. Likewise, each BAN 108 may serve as a server network to each of the smart HANs 110 coupled thereto as a client network. In some embodiments involving the smart HAN based on the client-server architecture, the clients in the smart HAN may comprise one or more smart objects, smart connected products, smart devices, smart meters, smart appliances and smart containers, all of which may be confined to one or more kitchen cabinets in a kitchen of a home, and at least one of smart portable and wearable computing and communications device, owned and operated by a user (owner). On the other hand, the server subsystem may comprise a host computing unit installed and residing in the premises of the home.

FIG. 1B depicts an exploded view of the smart HAN, of FIG. 1A, based on the client-server architecture, according to one or more embodiments.

The smart HAN 110 may comprise one or more Data Circuit-Terminating Equipments (DCEs), for instance a modem 116, router 118, network switch 120, wireless Access Point (AP) 122 and a network bridge 124, and the rest, a client subsystem 112 and a server subsystem 114. The smart HAN 110 may be in essence a type of Local Area Network (LAN) with the purpose to facilitate communication among digital devices present inside or within the close vicinity of a home. The devices capable of participating in the smart HAN 110, for example, smart devices, such as network printers and handheld mobile computers, often gain enhanced emergent capabilities through the ability of the participating devices to interact. The additional capabilities may be used to increase the Quality of Life (QOL) inside the home in a variety of ways, such as automation of repetitious tasks, increased personal productivity, enhanced home security, and easier access to entertainment. The smart HAN 110 may rely on one or more of the DCEs to establish physical layer, data link layer, and network layer connectivity both internally amongst devices and externally with outside networks. For example, and in no way limiting the scope of the embodiments, the smart HAN 110 may rely on one or more DCEs, for instance the modem 116, router 118, network switch 120, wireless Access Point (AP) 122 and network bridge 124, respectively. The modem 116 may be usually provided by a given Internet Service Provider (ISP) to expose an Ethernet interface to a given WAN via the telecommunications infrastructure of the ISP. In some scenarios involving the smart HAN 110, the modem may be at least one of a Digital Subscriber Line (DSL) modem or cable modem. The router 118 may facilitate managing network layer connectivity between the given WAN and the smart HAN 110. Most home networks feature a particular class of small, passively-cooled, table-top device with an integrated wireless AP and 4-port Ethernet switch. The aforementioned devices may facilitate installation, configuration, and management of the smart HAN 110 as automated, user friendly, and “plug-and-play” as possible. The network switch 120 may be used to allow devices, for instance the one or more smart objects, smart connected products, smart devices, smart meters, smart appliances and smart containers, all of which may be confined to one or more kitchen cabinets in a kitchen of a home, and at least one of smart portable and wearable computing and communications devices, owned and operated by users (owners), on the smart HAN 110 to communicate to one another via Ethernet. In some scenarios, the requirements of the smart HAN 110 may be fulfilled with Wi-Fi or the built-in switching capacity of the router 118. However, in some scenarios, the smart HAN 110 may require the introduction of a distinct switch 126 (not shown here explicitly). For example, in the event that at least one of the 1) requirement exceeds the switching capacity of the router 118, the router 118 may expose only 4 to 6 Ethernet ports; 2) power over Ethernet may be required by the devices, such as IP cameras and IP phones; and 3) distant rooms may have a large amount of wired devices in close proximity. The wireless AP 122 may be required for connecting the wireless devices to a given network. The network bridge 124 may facilitate connecting two network interfaces to each other, often in order to grant a wired-only device access to a given wireless network medium. In some embodiments, the smart HAN 110 may be based on at least one of wired and wireless technologies. For example, and in no way limiting the scope of the invention, the smart HAN 110 may use 1) Ethernet Category 5 cable (CAT 5), Category 6 cable (CAT 6) for speeds of 10 Mbit/s, 100 Mbit/s, 1 Gbit/s, or 10 Gbit/s; 2) Wi-Fi Wireless LAN connections for speeds up to 450 Mbit/s, subject to signal strength and wireless standard; 3) coaxial cables for speeds of 270 Mbit/s (Multimedia over Coax Alliance or MoCA); 4) electrical wiring for speeds of 14 Mbit/s to 200 Mbit/s (Power-Line Communication or PLC); 5) phone wiring for speeds of 160 Mbit/s (Home Phoneline Networking Alliance or HomePNA or HPNA); and 6) fiber optics. In some embodiments, design and implementation of the smart HAN via deployment of one or more wireless networking technologies is disclosed, in accordance with the principles of the present invention. For example, and in no way limiting the scope of the invention, the smart HAN 110 may be designed and implemented using IEEE 802.11 (Wireless Local Area Networks or WLAN), IEEE 802.15 (Wireless Personal Area Networks or WPAN), IEEE 802.15.4 (Low-Rate Wireless Personal Area Networks or LR-WPAN), and the like. In some exemplary embodiments, the smart HAN 110 may be designed and implemented using wireless radio signal technology, for instance the 802.11 network as certified by the IEEE. In use, most wireless-capable residential devices may operate at a frequency of 2.4 GHz under 802.11b and 802.11g or 5 GHz under 802.11a. However, some home networking devices may operate in both radio-band signals and fall within the 802.11n or 802.11ac standards. In some embodiments, low power, close range communication based on IEEE 802.15 standards may have a strong presence in the smart HAN 110. For instance, BLUETOOTH® continues to be the technology of choice for most wireless accessories, such as keyboards, mice, headsets, and game controllers. In operation, the low power, close range communication may be often established in a transient, ad-hoc manner, and thus may not often be seen as an act of expanding the smart HAN 110. In some embodiments, a “low-rate” version of the original WPAN protocol may be used as the basis of ZIGBEE®. Despite originally being conceived as a standard for low power machine-to-machine communication in industrial environments, the ZIGBEE® technology may be integration into embedded “Smart Home” offerings that may be expected to run on battery for extended periods of time. In operation, ZIGBEE® may utilize mesh networking to overcome the distance limitations associated with traditional WPAN in order to establish a single network of addressable devices spread across the entire building and network thereof, for instance the smart BAN 108. In some scenarios, Z-WAVE®, a newer standard also built on IEEE 802.15.4 (LR-WPAN) developed specifically for home automation devices, may be used.

In some embodiments, the smart HAN may comprise one or more general purpose devices. For example, and in no way limiting the scope of the invention, the smart Han 110 may comprise Personal Computers (PCs), such as desktops, laptops, netbooks, and tablets, one or more Network Attached Storage (NAS) devices easily accessible via at least one of the Common Internet File System (CIFS) and Network File System (NFS) protocols for general storage or for backup purposes, one or more print servers facilitating sharing any directly connected printers with other computers on the smart HAN 110, IP phones or smartphones (when connected via Wi-Fi) utilizing VoIP technologies, and the like.

The server subsystem 114 may comprise one or more home servers. The home server 114 may be located in the home providing services to other devices inside, for instance one or more smart objects, connected products, devices, meters, appliances and containers, all of which may be confined to one or more kitchen cabinets in a kitchen of a home, or outside the household through at least one of the smart HAN 110 and the Internet. For example, and in no way limiting the scope of the invention, the aforementioned services may include file and printer serving, media center serving, web serving (on the smart HAN 110 or Internet), web caching, account authentication and backup services.

For example, and in no way limiting the scope of the invention, in some embodiments, the home server 114 of the smart HAN 110 may render the following services: 1) administration and configuration services, such as the home server 114 may run headless, and may be administered remotely through a command shell, or graphically through a remote desktop system, such as Remote Desktop Protocol (RDP), Virtual Network Computing (VNC), Webmin, APPLE REMOTE DESKTOP™, or many others. In some scenarios, some Operating System (OS) for the home server 114, such as WINDOWS HOME SERVER™, may include a consumer-focused Graphical User Interface (GUI) for setup and configuration that is available on home computers on the smart HAN 110 (and remotely over the Internet via remote access); 2) the home server 114 of the smart HAN 110 may serve as Network-Attached Storage (NAS), thereby facilitating centralized and secure storage of all user files, with flexible permissions applied thereto. For example, servers running UNIX or LINUX with certain Windows Server products may facilitate domain control, custom logon scripts, and roaming profiles to users of certain versions of Windows; 3) the home server 114 of the smart HAN 110 may often serve to provide multi-media content, including photos, music, and video to other devices in the household and even to the Internet; 4) the home server 114 of the smart HAN 110 may serve to provide remote access into the home from devices on the Internet, using remote desktop software and other remote administration software. For example, WINDOWS HOME SERVER™ may provide remote access to files stored on the home server 114 via a web interface as well as remote access to Remote Desktop sessions on PCs in the house; 5) the home server 114 of the smart HAN 110 may serve as web server in order to share files easily and publicly (or privately, on the home network 114); 6) the home server 114 of the smart HAN 110 may comprise HTTP proxy, thereby facilitating speedy web access in the event that multiple users visit the same websites, and to get past blocking software; 7) the home server 114 of the smart HAN 110 may also run e-mail servers that handle e-mail for the home owner's domain name; 8) the home server 114 of the smart HAN 110 may facilitate security monitoring via deployment of relatively low cost Closed-Circuit Television (CCTV) Digital Video Recorder (DVR) solutions, thereby facilitating recordings of video cameras available to the home server 114, for security purposes. The recorded video may be viewed on PCs or other devices in the home; 9) the home server 114 of the smart HAN 110 may serve to act as a host to family-oriented applications, such as a family calendar, to-do lists, and message boards; 10) the home server 114 of the smart HAN 110 may serve to facilitate Internet Relay Chat (IRC) and Instant Messaging (IM) owing to the fact that the home server 114 is always “ON”, and thus the IRC client or IM client running on the home server 114 may be highly available to the Internet. As a consequence, in use, the chat client, for instance the IRC client or IM client, may be to record activity that occurs even while the user is not at the computer, e.g. asleep or at work or school; 11) the home server 114 of the smart HAN 110 may serve to facilitate private gaming.

The home server 114 of the smart HAN 110 may basically comprise a first microcomputer unit 170. The first microcomputer unit 170 may comprise a first microprocessor subunit 172, first memory subunit 174, a first Input/Output (I/O) subunit 176 and first support circuits 178, respectively. In addition, the home server 114 may comprise a first wireless communication transceiver subunit 180. Further, in addition, the home server 114 may optionally comprise a first display subunit 182. In some embodiments, the home server 114 may comprise a first GPS subunit 184 and a first GPRS subunit 186.

In some embodiments, the first memory subunit 174 may comprise a first Operating System (OS) 188, a Home Automation Module (HAM) 128 and a database server 190.

The first GPS unit (or GPS receiver unit) 184 may be capable of facilitating determination of position or location of the home server 114, smart devices 112, including the smart containers, with respect to a given geographic location. The first GPRS subunit 186 may be capable of facilitating transmission and reception (or exchange) of at least one of visual, video, data, facsimile and multimedia messages or information between one or more of at least one of smart portable and wearable computing and communications devices 112, the home server 114, the smart HAN 110 and the other smart devices 112. The HAM 128 may comprise a HAM application 129. The HAM application 129 may be coupled to one or more sensors 130, one or more controllers 132, one or more actuators 134, one or more buses 136 and one or more interfaces 138, respectively. The one or more sensors 130 may facilitate measuring or detecting one or more qualitative and quantitative parameters, such as temperature, humidity, daylight or motion. For example, and in no way limiting the scope of the invention, the one or more controllers 132 may comprise a PC or a dedicated home automation controller. Further, the one or more actuators 134 may comprise motorized valves, light switches and motors. Still further, the one or more buses may facilitate at least one of wired and wireless communication. Finally, the one or more interfaces 136 may comprise at least one of human-to-machine, machine-to-machine, and a combination thereof for interaction. In some embodiments, one or more interface devices for at least one of human-to-machine, machine-to-machine, and a combination thereof interaction may be required, thereby facilitating the residents of the home to interact with the HAM for monitoring and control. For example, and in no way limiting the scope of the invention, the interface devices may be a specialized (dedicated) terminal or, increasingly, may be a proprietary application (app) running on at least one of a smart phone (mobile app) and tablet computer. Devices may communicate at least one of over a dedicated wiring, over a wired network and wirelessly using one or more protocols. The BAN may be adapted to control in individual homes, and the smart HAN thereof. For example, and in no way limiting the scope of the invention, in some scenarios, at least one of a centralized controller may be used and multiple intelligent devices may be distributed around the home, and the smart HAN thereof. The database server 190 may facilitate rendering database services to other computer programs or computers, for instance, the smart devices, containers, portable or wearable computing and communication devices of the client subsystem 112, as defined by the client-server model. In some scenarios, the home server 114 of the smart HAN 114 may be dedicated to running the database server 190. Database Management Systems (DBMSs) frequently provide database server functionality, and some DBMSs (e.g., MYSQL®) rely exclusively on the client-server model for database access. In use, the database server 190 may be accessed at least one of 1) through a frontend application running on each of smart devices 112 including the at least one of portable and wearable computing and communications devices, which displays requested data, and a backend application, which runs on the home server 114 and handles tasks, such as data analysis and storage. As depicted in FIG. 1A, the client subsystem 112 may comprise one or more of at least one of smart objects, connected products, devices, meters, appliances and containers, all of which may be confined to one or more kitchen cabinets in a kitchen of a home, and at least one of smart portable and wearable computing and communications devices, owned and operated by users (owners). For example, in some embodiments, the smart physical objects, smart connected products, smart devices, smart meters, smart appliances and smart containers may be at least one of wiredly and wirelessly chargeable. In addition, in some embodiments, the smart physical objects, smart connected products, smart devices, smart meters, smart appliances and smart containers may be at least one of portable and fixed. Alternatively, in some embodiments, the smart computing and communications devices may be at least one of wiredly and wirelessly chargeable. In addition, the smart computing and communications devices may be at least one of portable, wearable and fixed.

In some embodiments, the smart computing and communications devices may comprise plurality of at least one of a portable computing device, portable communications device and a combination thereof, for instance a portable computing and communications device. In some embodiments, the portable computing devices may be at least one of a portable computer, tablet computer, Personal Digital Assistant (PDA), an ultra mobile PC, a smart phone, carputer, portable communications, pentop computer, and the like. Likewise, in some embodiments, the portable communications devices may be at least one of a mobile device, and the like. In some embodiments, the smart computing and communications devices may comprise one or more of at least one of a wearable computing device, wearable communications device and a combination thereof, for instance a wearable computing and communications device. For example, and in no way limiting the scope of the invention, the wearable computing devices may be at least one of a smart watch, smart band, smart glass, smart shoe, and the like.

In some embodiments, the smart devices 112 may be smart portable chargeable home appliances, for instance small home appliances including, but not limited to, heating, food processing and cooking appliances, such as food preparation appliances, ovens, stoves, and other major home appliances including, but not limited to, freezers, coolers, dishwashers, water heaters, utility meters, such as smart electricity, gas, water and heat meters.

FIG. 1C depicts an exploded block diagrammatic view of the smart device, according to one or more embodiments.

In some embodiments, as depicted in FIG. 1C, each of the smart devices 112 may comprise a second microcomputer unit 140. The second microcomputer unit 140 may comprise a second microprocessor subunit 142, second memory subunit 144, a second Input/Output (I/O) subunit 146 and second support circuits 148, respectively. In addition, each of the smart devices 112 may comprise a second wireless communication transceiver subunit 150. Further, in addition, each of the smart devices 112 may optionally comprise a second display subunit 152. In some embodiments, each of the smart devices 112 may comprise a second GPS subunit 154 and a second GPRS subunit 156. Alternatively, in some embodiments, each of the smart devices 112 may comprise a smart Radio Frequency Identification (RFID) tag 192 (not shown here explicitly). For example, and in no way limiting the scope of the invention, the smart RFID tag 192 may be at least one of Write Once and Read Many times (WORM) and Write Many Read Many times (WMRM). In some scenarios, the smart RFID tag 192 may be capable of facilitating automatic detection or identification of the smart devices 112.

In some embodiments, the second memory subunit of each of the smart devices (clients) may be capable of facilitating storage and management of any and all information of, for and by the smart device. The second memory subunit may be capable of facilitating storage and implementation of proprietary application software and embedded software, for instance device drivers, firmware and Database Management System (DBMS) thereby facilitating smart overall management of the aforementioned information. For purposes of clarity and expediency, collectively the proprietary application software, embedded software and firmware may be hereinafter interchangeably referred to as at least one of the proprietary software plus firmware and a smart device management module.

As depicted in FIG. 1C, the second memory subunit 144 may comprise a second Operating System (OS) 158, the smart device management module 160 and a DBMS 162. For example, and in no way limiting the scope of the invention, the second OS 158 may be a Reduced Instruction Set Computing (RISC) OS, for instance RISC/OST™. For example, and in no way limiting the scope the invention, the DBMS 162 may be an at least one of a micro and pico DBMS 162.

In some embodiments, the DBMS may be capable of facilitating storage and management of the aforementioned information of, for and by the smart devices in the form of one or more records. Specifically, each individual record may be stored in a database, wherein each individual record may comprise one or more attributes or fields. More specifically, the one or more attributes may comprise the aforementioned information of, for and by the smart devices and corresponding metadata therefor. The DBMS may be capable of facilitating at least one of sequential, random and customized searching (or scanning) of one or more records comprising the aforementioned information and corresponding metadata therefor, based on one or more criterion, for instance explicit user-definable criteria.

The DBMS 162 may comprise a front end application 164 (not shown here explicitly), backend application 166 (not shown here explicitly) and backend database 168 (not shown here explicitly). For example, and in no way limiting the scope of the invention, the front end and backend applications 164 and 166 may correspondingly serve as the client-side front end and server-side backend for the smart device management module 160. Further, for example, and in no way limiting the scope of the invention, the backend database 168 may be an In-Memory (IMDB), also Main Memory Database System (MMDB) (or memory resident database) 168.

In some embodiments, the front end application may be capable of collecting or receiving inputs, for instance data feeds and queries, in various forms from the user, for instance through a customized Graphical User Interface (GUI) rendered on the at least one of portable and wearable computing and communications device owned by the user, and processing the same to conform to a specification both the back end application and database may be capable of consuming. The front end application may be capable of serving as an interface between the user and the backend application and database.

In some embodiments, for example, the front end and backend applications may be correspondingly distributed amongst at least one of portable and wearable computing and communications device 112 owned by the user, and the smart device 112 respectively, for instance the second memory subunit 144 in the second microcomputer unit 112 of the smart device 112. For purposes of clarity and expediency, the front end application may be hereinafter referred to as user-side front end application.

In some embodiments, the backend database may be capable of storing the aforementioned information of, for and by the smart devices received from the at least one of portable and wearable computing and communications devices. In some embodiments, the one or more of the at least one of portable and wearable computing and communications devices may be capable of sending at least one of text and visual messages via the Short Message Service (SMS) to the smart devices.

The second GPS unit (or GPS receiver unit) 154 may be capable of facilitating determination of position or location of the smart devices 112, including the smart containers, with respect to a given geographic location.

The second GPRS subunit 156 may be capable of facilitating transmission and reception (or exchange) of at least one of visual, video, data, facsimile and multimedia messages or information between one or more of at least one of smart portable and wearable computing and communications devices 112, the smart HAN 110 and the other smart devices 112.

In some embodiments, smart overall management of the smart home (kitchen), smart devices as well as smart containers therein, and users thereof using smart portable and wearable computing and communications devices is disclosed, in accordance with the principles of the present invention. Specifically, the at least one of portable and wearable, chargeable computing and communications devices may facilitate smart overall management of at least one of smart and non-smart (or non-intelligent or dummy) home appliances, devices and gastronorm containers, in accordance with the principles of the present invention. In some scenarios involving deployment of the non-smart (or non-intelligent or dummy) home appliances, devices and gastronorm containers, the non-smart (or non-intelligent or dummy) home appliances, each of the non-smart (or non-intelligent or dummy) home appliances, devices and gastronorm containers may be transformed to smart home appliances, devices and gastronorm containers via integration of a retrofit module, designed and implemented in accordance with the principles of the present invention. In some embodiments, the method and system of the present invention may facilitate capturing overall data or information in connection with one or more entities, such as the smart kitchens, smart portable chargeable objects, smart connected products, smart devices, smart meters, smart appliances, smart containers, substances contained therein, all of which may be confined to one or more kitchen cabinets in a kitchen of a home, at least one of smart portable and wearable computing and communications devices owned and operated by users (owners), the users, and the relationships therebetween, analyzing the captured information, building applicable and relevant contexts, profiling the entities based on the analysis of the captured information, categorizing the entities based on the generated profiles and rendering relevant recommendations in connection with the management and use of the entities, and other related matters based on the generated contexts.

In some embodiments, the captured data or information in connection with the entities, the external as well as internal ambience thereof, for example the smart kitchens, devices, appliances and containers, may comprise one or more qualitative and quantitative parameters, such as A) intrinsic or native attributes of the smart devices, appliances and containers, for instance at least one of the design, technical, functional, performance, color, operational, material, state, constructional, geometrical, dimensional specifications and one or more applicable and relevant combinations thereof; B) intrinsic or native attributes of the substances contained in the smart containers (food contact materials), for instance at least one of the phase of the substances, color, material, texture, flavor, and one or more applicable and relevant combinations thereof; C) intrinsic or native attributes of the smart kitchen and the shelves therein, for instance at least one of design, architectural, configuration, constructional, geometrical, dimensional specifications, number of the kitchen shelves, and one or more applicable and relevant combinations thereof; E) intrinsic or native attributes of the users, for instance, the cooking skill, such as amateur or professional, cooking history and behaviour, such as average number of times or frequency of cooking in a given time period, recipes cooked or prepared, personal details or information, eating history and behaviour, such as taste, preferred recipes, details of friends, family, peers and contacts contacted for advice or rendered advice, and one or more applicable and relevant combinations thereof; F) extrinsic attributes, i.e. at least one of by way of storage, usage, use, existence and one or more applicable and relevant combinations thereof, of the smart devices, appliances and containers, for instance at least one of long and short term usage history and behaviour, such as the frequency of use in a given time period, uptime, downtime, total number of hours of use or working hours, current status, current working condition, recommended purposes of use, number of types of breakdowns, number of times overhauled, the current locations or positions in a given smart networked or connected kitchen relative to the cabinets thereof and optionally in any given point in time, and one or more applicable and relevant combinations thereof; G) extrinsic attributes, i.e. at least one of by way of storage, usage, use, existence and one or more applicable and relevant combinations thereof, of the substances contained in the smart containers (food contact materials), for instance at least one of the levels and amounts, i.e. volumes and weights, of the substances at any given time period (point in time), inventory turnovers, dates, and times of day thereof, of filling at the commencement of any given time period, average frequency of filling in any given time period, average frequency of use or consumption in any given time period, the average amounts used or consumed, for instance difference in levels prior and subsequent to consumption, volumes and weights, per use or consumption in any given time period, dates, and times of day thereof, of last use in any given time period, expiry information, average amounts filled periodically, for instance difference in levels, such as prior and subsequent to filling, volumes and weights, average storage temperatures, average storage humidity, numbers and types of recipes prepared therefrom in any given time period, wherein any of the given substances was used as ingredients, and the average amount used or consumed therefor, dedicated seller and store information therefor, and one or more applicable and relevant combinations thereof; H) extrinsic attributes, i.e. at least one of by way of storage, usage, use, existence and one or more applicable and relevant combinations thereof, of the smart kitchen, for instance, the overall inventory turnovers, dedicated store and seller information, if any, details of the cooks and the corresponding recipes prepared therein in any given time period, number of the smart containers and corresponding identifiers and contents information, and one or more applicable and relevant combinations thereof; I) extrinsic attributes, i.e. at least one of by way of storage, usage, use, existence and one or more applicable and relevant combinations thereof, of the external and internal ambient conditions, for instance, in-house (indoor) temperature, humidity, light, casual domestic events, formal events, such as parties or gatherings, outdoor temperature, humidity, light, weather, climate, season, casual public events, formal public events, festivals or holidays, and one or more applicable and relevant combinations thereof.

In some embodiments involving realization of social cooking in the context of smart community networks (or Neighborhood Area Networks (NANs)) comprising one or more Building Area Networks (BANs), in turn, comprising one or more smart Home Area Networks (HANs), the method and system of the present invention may facilitate design and implementation of a social cooking network, and hosting of at least one of a web (or online) portal and an On Device Portal (ODP) therefor accessible via one or more of the at least one of smart portable and wearable, chargeable computing and communications devices, in accordance with the principles of the present invention. Specifically, the social cooking network may facilitate participation of contacts or connections of a primary user including, but not limited to, at least one of amateur cooks, professional cooks, colleagues, peers, friends and family members thereof. More specifically, the social cooking network may further facilitate users to extend the functionality of the system to the contacts or connections of the first (1st)-level connections of the primary user. Still, more specifically, the system may facilitate the user to set the limit to which the system may include the contacts. For instance, the primary user may only wish to include the contacts of the contacts of the primary user (i.e. second (2^{nd})-level connections), but may be able to extend the contacts out as far as the user may like (i.e., Nth-level depth of contacts for Nth-level connections). In addition, the social cooking network may facilitate at least one of search and generation, analysis, selection, profiling, categorization, recommendation and exchange of information in connection with culinary, tourism related thereto, for instance culinary (or food or enotourism) and the like, culinology, gastronomy, eateries, recipes, chefs or cooks, food festivals, cook-offs, and the rest, amidst the primary users and the contacts thereof, thereby facilitating culinary management, recipe management, culinary tourism management, culinary networking, dietary, weight and nutrition management.

In some embodiments involving implementation of both individual and social cooking in the context of one or more smart HANs constituting the one or more BANs, in turn, constituting one or more NANs, the present method and system may facilitate smart automation management of the aforementioned smart physical objects, smart connected products, smart devices, smart meters, smart appliances and smart containers using the aforementioned smart computing and communications devices, in accordance with the principles of the present invention.

Specifically, the present methods and systems may facilitate both individual and social cooking via smart overall management of the aforementioned smart kitchens, smart objects, connected products, devices, meters, appliances, containers using the aforementioned smart computing and communications devices in the smart BANs comprising the one or more smart HANs based on at least one of definition and identification, analysis, selection and determination of at least one of context-sensitive, context-dependent and context-aware qualitative and quantitative parameters thereof, thereby facilitating building of current applicable and relevant contexts therefor. More specifically, the present methods and systems may facilitate analysis of any and all of the data or information captured and mentioned hereinbefore, profiling the entities based on the captured data or information, categorizing the entities based on the profiles, and recommending optimal kitchen, inventory and recipe (cooking or culinary) management techniques, in accordance with the principles of the present invention. In addition, the present methods and systems combined with the deployment of the social cooking network may facilitate at least one of search and generation, analysis, selection, profiling, categorization, recommendation and exchange of information in connection with culinary, tourism related thereto, for instance culinary (or food or enotourism) and the like, culinology, gastronomy, eateries, recipes, chefs or cooks, food festivals, cook-offs, and the rest, amidst the primary users and the contacts thereof, thereby facilitating culinary management, recipe management, culinary tourism management, culinary networking, dietary, weight and nutrition management.

In some embodiments, for example, and in no way limiting the scope of the present invention, the at least one of portable and wearable, chargeable computing and communications devices may facilitate searching (detecting or scanning), identifying (recognizing), locating (positioning) the smart devices or containers, selecting the searched, identified and located smart devices or containers for bi-directional communication therewith, accessing and retrieving any and all of the aforementioned intrinsic and extrinsic attributes of the smart devices or containers, for instance the usage as well as performance history and behaviour of the smart devices or containers, processing, analyzing, monitoring and tracking the any and all of the aforementioned intrinsic and extrinsic attributes of the smart devices or containers, and any and all changes thereof with respect to any given time period, remotely (wirelessly) controlling (managing) functions of, and information of, for or by, the smart devices or containers, and rendering relevant recommendations in connection with the any and all of the aforementioned intrinsic and extrinsic attributes of the smart devices or containers, for instance the usage, handling, current status, working condition, frequency of use, uptime, downtime, in accordance with the principles of the present invention.

In some embodiments, methods and systems for facilitating locating, positioning and tracking of the smart portable chargeable gastronorm containers located in the kitchen and confined to, or positioned, on one or more kitchen shelves thereof, and systems therefor are disclosed, in accordance with the principles of the present invention. Specifically, each of the at least one of smart portable and wearable chargeable computing and communications devices may comprise proprietary application software for facilitating locating, positioning and tracking of the smart portable chargeable canisters or gastronorms. For example, and in no way limiting the scope of the invention, the methods and systems of the present invention may facilitate locating, positioning and tracking of the smart portable chargeable canisters located in the kitchen and confined to, or positioned, on one or more kitchen shelves thereof via implementation of at least one of Wi-Fi-based Positioning System (WPS or WiPS/WFPS), Indoor Positioning System (IPS), Local Positioning System (LPS), Real-Time Locating System (RTLS) and Hybrid Positioning System (HPS), in accordance with the principles of the present invention.

In some embodiments involving deployment of the IPS, the IPS may facilitate locating objects or people inside a building using at least one of radio waves, magnetic fields, acoustic signals, and other sensory information collected by the at least one of smart portable and wearable chargeable computing and communications devices. In use, the IPS relies on different technologies including, but not limited to, distance measurement to nearby anchor nodes (nodes with known positions, e.g., Wi-Fi Access Points (APs)), magnetic positioning, dead reckoning, instead of using satellites. Specifically, in use, the IPS may at least one of facilitate actively locating the at least one of smart portable and wearable chargeable computing and communications devices plus tags, for instance smart tags embedded upon or integrated to the smart portable chargeable canisters or gastronorms, and providing ambient location or environmental context for the devices or the smart portable chargeable canisters or gastronorms to get sensed. For example, and in no way limiting the scope of the invention, from the design and implementation perspective, the IPS may use at least one of optical, radio and acoustic technologies by virtue of localized nature of the IPS. In addition, from the design and implementation perspective, the IPS may take into account that at least three independent measurements to unambiguously find a location, for instance as in trilateration. In some scenarios involving error budget management, in order to compensate for stochastic (unpredictable) errors smoothing or smoothening may be based on sound method, thereby facilitating reducing error budget significantly. Alternatively, in some scenarios, the IPS may include information from other systems to cope for physical ambiguity and to enable error compensation.

In some embodiments involving deployment of the WPS or WiPS/WFPS, the WPS or WiPS/WFPS may facilitate positioning in the event that the GPS may be inadequate owing to various causes including multipath and signal blockage indoors. In use, the localization technique used for positioning with wireless APs is based on measuring the intensity of the received signal (Received Signal Strength or RSS) and the method of “fingerprinting”. For example, the typical parameters useful to geolocate the Wi-Fi hotspot or wireless AP include the Service Set Identifier (SSID) and the Media Access Control (MAC) address of the AP. The accuracy depends on the number of positions entered into the Wi-Fi hotspot database. In use, the Wi-Fi hotspot database may get populated or filled by correlating the location data of the GPS unit of the mobile device with the MAC addresses of the Wi-Fi hotspots.

In some embodiments involving deployment of the RTLS, the RTLS may facilitate automatically identifying and tracking the location of objects or people in real time, usually within a building or other contained area. In use, Wireless RTLS tags may be attached to objects or worn by people, and in most RTLS, fixed reference points may receive wireless signals from the tags to determine the location thereof. Examples of RTLSs include tracking automobiles through an assembly line, locating pallets of merchandise in a warehouse, or finding medical equipment in a hospital. For example, and in no way limiting the scope of the invention, the present method and system may use at least one of the following technologies Active Radio Frequency Identification (Active RFID), Active Radio Frequency Identification-Infrared hybrid (Active RFID-IR), Infrared (IR), optical locating, low-frequency signpost identification, semi-active Radio Frequency Identification (semi-active RFID), Passive RFID RTLS locating via Steerable Phased Array Antennae, radio beacon, Ultrasound Identification (US-ID), Ultrasonic Ranging (US-RTLS), Ultra-Wideband (UWB), wide-over-narrow band, Wireless Local Area Network (WLAN, Wi-Fi), BLUETOOTH®, clustering in noisy ambience, bivalent systems and one or more potential combinations thereof.

In some embodiments involving deployment of the HPS, the HPS may facilitate finding the location of a mobile device using several different positioning technologies. The GPS may be one major component of the HPS, combined with cell tower signals, wireless internet signals, Bluetooth sensors, IP addresses and network environment data. The HPS may facilitate overcoming the limitations of the GPS, which may be exact in open areas, but may work poorly indoors or between tall buildings (the urban canyon effect). By comparison, cell tower signals may not be hindered by buildings or bad weather, but may usually provide less precise positioning. Wi-Fi positioning systems may give exact positioning, in urban areas with high Wi-Fi density and depend on a comprehensive database of Wi-Fi access points.

In some embodiments, methods and systems for smart overall management of the smart portable chargeable gastronorm containers (food storage canisters) using the smart portable or wearable chargeable portable computing and communications devices are disclosed, in accordance with the principles of the present invention. Specifically, methods and systems for smart management of one or more qualitative and quantitative parameters in connection with the smart portable chargeable gastronorm containers (food storage canisters) and the substances contained therein using a proprietary app installed on the smart portable or wearable chargeable portable computing and communications devices based on one or more techniques are disclosed, in accordance with the principles of the present invention. More specifically, one or more techniques for facilitating smart management of, for instance measuring, amount, for instance level, volume or weight, of the food or edible items contained in the smart portable chargeable gastronorm containers (food storage canisters) using the proprietary app installed on the smart portable or wearable chargeable portable computing and communications devices are disclosed, in accordance with the principles of the present invention. Still, more specifically, techniques facilitating at least one of detecting the levels of the food (edible or substances) items stored in the smart portable chargeable food storage canisters, monitoring (analyzing) the detected levels of the food (edible or substances) items thereof, tracking changes in the levels with respect to given time periods owing to usage or consumption of the food or edible items in those time periods and generating recommendations in connection with inventory management, for instance inventory turnovers, based on the results of detection, monitoring or analysis and tracking of the levels of the food or edible items stored in the smart portable chargeable food storage canisters. In addition, techniques facilitating locating, positioning and tracking the smart portable chargeable food storage canisters is disclosed, in accordance with the principles of the present invention.

In some embodiments, methods and systems for managing the smart portable chargeable gastronorm containers (food storage canisters) using the at least one of smart portable and wearable chargeable computing and communications devices are disclosed, in accordance with the principles of the present invention. Specifically, methods and systems for managing one or more parameters in connection with the substances contained in the smart portable chargeable gastronorm containers (food storage canisters) using a proprietary app installed on the at least one of smart portable and wearable chargeable computing and communications devices based on one or more techniques are disclosed, in accordance with the principles of the present invention. More specifically, one or more techniques for facilitating managing, for instance measuring amounts, i.e. levels, volumes or weights, of the food or edible items contained in the smart portable chargeable gastronorm containers (food storage canisters) using the proprietary app installed on the at least one of smart portable and wearable chargeable computing and communications devices are disclosed, in accordance with the principles of the present invention. Still, more specifically, techniques facilitating at least one of detecting the levels of the food (edible or substances) items stored in the smart portable chargeable food storage canisters, monitoring (analyzing) the detected levels of the food (edible or substances) items thereof, tracking changes in the levels with respect to given time periods owing to usage or consumption of the food or edible items in those time periods and generating recommendations in connection with inventory management, for instance inventory turnovers, based on the results of detection, monitoring or analysis and tracking of the levels of the food or edible items stored in the smart portable chargeable food storage canisters.

In some optional embodiments involving deployment of the level sensors, the level sensors may facilitate detecting the level of liquids, other fluids and fluidized solids, including slurries, granular materials, and powders that exhibit an upper free surface. However, substances that flow become essentially horizontal in the smart portable chargeable food storage canisters (or other physical boundaries) owing to gravity, whereas most bulk solids may pile at an angle of repose to a peak. Fundamentally, the level measurement may be at least one of continuous and point values. In some scenarios involving continuous level measurement, the continuous level sensors measure level within a specified range and determine the exact amount of substance in a certain place, whereas in some other scenarios involving point values level measurement, the point-level sensors only indicate whether the substance is above or below the sensing point. In use, the point-level sensors detect levels that are at least one of excessively high and low. In some embodiments involving implementation of the optimal level monitoring method for industrial and commercial processes, there are many physical and application variables that may affect the selection of the optimal level monitoring method for industrial and commercial processes. Specifically, the selection criteria may take into consideration the physical variables comprising at least one of phase, for instance liquid, solid or slurry, temperature, pressure (vacuum), chemistry, dielectric constant of medium, density (specific gravity) of medium, agitation (action), acoustical noise, electrical noise, vibration, mechanical shock, canister dimensional specifications, canister geometrical specifications and a combination thereof. In addition, the selection criteria may take into consideration the application constraints comprising at least one of price, accuracy, appearance, response rate, ease of calibration (programming), physical size, mounting of the instrument, monitoring of continuous or discrete (point) levels, control of continuous or discrete (point) levels and a combination thereof. Further, the level sensors may be important sensors, and thus play important role in variety of consumer or industrial applications. Like other type of sensors, the level sensors are available or may be designed using variety of sensing principles. Selection of an appropriate type of sensor suiting to the application requirement is important.

In some optional embodiments involving point and continuous level detection for solids, a variety of sensors are available and, thus may be used for point level detection of solids. For example, and in no way limiting the scope of the invention, the sensors for point level detection of solids may include at least one of vibrating, rotating paddle, mechanical (diaphragm), microwave (radar), capacitance, optical, pulsed-ultrasonic and ultrasonic level sensors.

In some optional embodiments, the vibrating point level sensors may facilitate detecting levels of very fine powders, for instance with bulk density ranging from a minimum of approximately 0.02 g/cm³ to a maximum of approximately 0.2 g/cm³, fine powders, for instance with bulk density ranging from a minimum of approximately 0.2 g/cm³ to a maximum of approximately 0.5 g/cm³, and granular solids, for instance with bulk density ranging from at least a minimum of approximately 0.5 g/cm³ and greater. With proper selection of vibration frequency and suitable sensitivity adjustments, the vibrating point level sensors may also sense the level of highly fluidized powders and electrostatic materials. In some scenarios, single-probe vibrating level sensors may be ideal for bulk powder level. In use, since only one sensing element may contact the powder, bridging between two probe elements may be eliminated and media build-up may be minimized. Further, in use, the vibration of the probe may tend to eliminate build-up of material on the probe element. The vibrating level sensors may not be affected by dust, static-charge build-up from dielectric powders, or changes in conductivity, temperature, pressure, humidity or moisture content. In some scenarios, tuning-fork style vibration sensors may be another alternative. The tuning-fork style vibration sensors may be less costly, however may be prone to material buildup between the tines.

In some optional embodiments, rotating paddle level sensors may serve as bulk solid point level indicator. In use, the rotating paddle level sensors may use a low-speed gear motor to rotate a paddle wheel. In some scenarios, in the event that the paddle may be stalled by solid materials, the motor may be rotated on the shaft thereof by self-torque, until a flange mounted on the motor contacts a mechanical switch. The paddle may be constructed from a variety of materials, but tacky material may not be allowed to build up on the paddle. In some scenarios, build-up may occur in the event that the process material becomes tacky because of high moisture levels or high ambient humidity in the hopper. For materials with very low weight per unit volume, such as Pearlite, Bentonite or fly ash, special paddle designs and low-torque motors may be used. Fine particles or dust may be prevented from penetrating the shaft bearings and motor by proper placement of the paddle in the hopper or bin and using appropriate seals.

In some optional embodiments, an RF admittance level sensor may use a rod probe and an RF source to measure the change in admittance. In use, the probe may be driven through a shielded coaxial cable to eliminate the effects of changing cable capacitance to ground. In some scenarios, in the event that the level changes around the probe, a corresponding change in the dielectric may be observed. Further, the change in the dielectric owing to the change in the level around the probe may change the admittance of the imperfect capacitor, which change in the admittance may be measured to detect change of level.

In some optional embodiments involving point level detection of liquids, varieties of sensors are available and, thus may be used for point level detection of liquids. For example, the sensors for point level detection of liquids may include at least one of magnetic and mechanical float, pneumatic and conductive level sensors.

In some optional embodiments, the magnetic, mechanical, cable, and other float level sensors may involve the opening or closing of a mechanical switch, at least one of through direct contact with the switch and magnetic operation of a reed. In some scenarios involving deployment of magnetically actuated float sensors, switching occurs in the event that a permanent magnet sealed inside a float at least one of rises and falls to the actuation level. In some scenarios involving deployment of a mechanically actuated float, switching occurs as a result of the movement of a float against a miniature (micro) switch. For both magnetic and mechanical float level sensors, chemical compatibility, temperature, specific gravity (density), buoyancy, and viscosity may affect the selection of the stem and the float. For example, larger floats may be used with liquids with specific gravities as low as 0.5, while still maintaining buoyancy. The choice of float material may also be influenced by temperature-induced changes in specific gravity and viscosity, which changes that directly affect buoyancy. In some scenarios, float-type sensors may be designed so that a shield protects the float from turbulence and wave motion. In use, the float sensors may operate well in a wide variety of liquids, including corrosives. However, in some scenarios, in the event that the float sensors may be used for organic solvents, it may be necessary to verify that the liquids (organic solvents) are chemically compatible with the materials used to construct the sensor. Still however, the float-style sensors may not be used with high viscosity (thick) liquids, sludge or liquids that adhere to the stem or floats, or materials that contain contaminants, such as metal chips. In some applications, the float type sensors may facilitate determining the interface level in oil-water separation systems. Specifically, in use, two floats may be used in which each float may be sized to match the specific gravity of the oil on one hand, and the water on the other. Another special application of a stem type float switch may be the installation of temperature or pressure sensors to create a multi-parameter sensor. Magnetic float switches are popular for simplicity, dependability and low cost.

In some optional embodiments, pneumatic level sensors may be used in at least one of existence of hazardous conditions, power outage, restricted power usage, in applications involving heavy sludge (slurry) and a combination thereof. In use, the compression of a column of air against a diaphragm may be used to actuate a switch, no process liquid contacts the moving parts of the pneumatic level sensors. The pneumatic level sensors may be suitable for use with highly viscous liquids, such as grease, as well as water-based and corrosive liquids. The pneumatic level sensors may have the additional benefit of being a relatively low cost technique for point level monitoring.

In some embodiments involving sensors for both point level detection and continuous monitoring, ultrasonic level sensors may be used for non-contact level sensing of highly viscous liquids, as well as bulk solids. The ultrasonic level sensors may also be widely used in water treatment applications for pump control and open channel flow measurement. In operation, the ultrasonic level sensors may emit high frequency (20 kHz to 200 kHz) acoustic waves that are reflected back to and detected by the emitting transducer. The ultrasonic level sensors may also be affected by the changing speed of sound due to moisture, temperature, and pressure. Correction factors may be applied to the level measurement to improve the accuracy of measurement. Turbulence, foam, steam, chemical mists (vapors), and changes in the concentration of the process material also affect the response of ultrasonic sensors. In use, turbulence and foam prevent the sound wave from being properly reflected to the sensor, whereas steam and chemical mists and vapors distort or absorb the sound wave, and variations in concentration cause changes in the amount of energy in the sound wave that is reflected back to the ultrasonic sensor. Stilling wells and wave guides may be used to prevent errors caused by the aforementioned factors.

In some embodiments involving deployment of the ultrasonic sensors, in use proper mounting of the transducer may be required to ensure best response to reflected sound. In addition, the hopper, bin, or tank should be relatively free of obstacles, such as welding, brackets, or ladders to minimize false returns and the resulting erroneous response, although most modern systems have sufficiently “intelligent” echo processing to make engineering changes largely unnecessary, except where an intrusion blocks the “line of sight” of the transducer to the target. Since the ultrasonic transducer may be used both for transmitting and receiving the acoustic energy, the ultrasonic transducer may be subject to a period of mechanical vibration known as “ringing”. The mechanical vibration or ringing must attenuate (stop) before the echoed signal may be processed. The net result may be a distance from the face of the transducer that may be blind and fails to detect an object. The distance from the face of the transducer that may be blind and fails to detect an object is known as the “blanking zone”, typically 150 mm-1 m, depending on the range of the transducer. In use, an electronic signal processing circuitry may be used to make the ultrasonic sensor an intelligent device. Ultrasonic sensors may be designed to provide point level control, continuous monitoring or both. Due to the presence of a microprocessor and relatively low power consumption, the ultrasonic sensor may be capable of performing serial communication from and to other computing devices, thereby facilitating adjusting calibration and filtering of the sensor signal, remote wireless monitoring or plant network communications.

In some optional embodiments involving deployment of sensors for both point level detection and continuous monitoring, capacitance level sensors may excel in sensing the presence of a wide variety of solids, aqueous and organic liquids, and slurries. The technique of deploying capacitance level sensors may be frequently referred to as RF for the Radio Frequency signals applied to the capacitance circuit. In some scenarios, the capacitance level sensors may be designed to sense material with dielectric constants as low as 1.1, for instance coke and fly ash, and as high as 88, for instance water, or more. Sludges and slurries, such as dehydrated cake and sewage slurry (dielectric constant approx. 50), and liquid chemicals, such as quicklime (dielectric constant approx. 90), may also be sensed. Dual-probe capacitance level sensors may also be used to sense the interface between two immiscible liquids with substantially different dielectric constants, providing a solid state alternative to the aforementioned magnetic float switch for the “oil-water interface” application. Since, the capacitance level sensors are electronic devices, phase modulation and the use of higher frequencies may make or render the sensor suitable for applications in which dielectric constants are similar. The capacitance level sensor contains no moving parts, is rugged, simple to use, and easy to clean, and may be designed for high temperature and pressure applications. However, a danger exists from build-up and discharge of a high-voltage static charge that may result from the rubbing and movement of low dielectric materials, but the danger may be eliminated with proper design and grounding.

In use, appropriate choice of probe materials may reduce or eliminate problems caused by abrasion and corrosion. Point level sensing of adhesives and high-viscosity materials, such as oil and grease, may result in the build-up of material on the capacitance level probe, however the build-up may be minimized by using a self-tuning sensor. For liquids prone to foaming and applications prone to splashing or turbulence, the capacitance level sensors may be designed with splashguards or stilling wells, among other devices.

However, a significant limitation for the capacitance probes may be in case of tall bins used for storing bulk solids. The requirement for a conductive probe that extends to the bottom of the measured range may be problematic. Long conductive cable probes, for instance 20 to 50 meters long, suspended into the bin or silo, may be subjected to tremendous mechanical tension due to the weight of the bulk powder in the silo and the friction applied to the cable, thereby resulting in frequent cable breakage.

In some optional embodiments involving deployment of sensors for both point level detection and continuous monitoring, optical sensors may be used for point level sensing of sediments, liquids with suspended solids, and liquid-liquid interfaces. The optical sensors may sense the decrease or change in transmission of Infrared (IR) light emitted from an Infrared (IR) Light Emitting Diode (LED). With the proper choice of construction materials and mounting location, the optical sensors may be used with aqueous, organic, and corrosive liquids. A common application of economical IR-based optical interface point level sensors may be in detecting the sludge/water interface in settling ponds. By using pulse modulation techniques and a high power IR LED, the interference from ambient light may be eliminated, facilitating operating the IR LED at a higher gain, thereby facilitating lessening the effects of build-up on the probe. An alternate approach for continuous optical level sensing may involve the use of a laser. In use, laser light may be more concentrated, and therefore may be more capable of penetrating dusty or steamy environments. Laser light may reflect off most solid, liquid surfaces. The time of flight may be measured with precise timing circuitry, to determine the range or distance of the surface from the sensor. However, lasers remain limited from the perspective of use in industrial applications due to cost and maintenance concerns. The optics may be frequently cleaned to maintain performance.

In some optional embodiments involving deployment of sensors for both point level detection and continuous monitoring, microwave sensors may be ideal for use in moist, vaporous, and dusty environments as well as in applications in which temperatures and pressures vary. In use, microwaves (also frequently described as RADAR), may penetrate temperature and vapor layers that may cause problems for other techniques, such as ultrasonic. Microwaves are electromagnetic energy and therefore do not require air molecules to transmit the energy making the microwaves useful in vacuums. Microwaves, as electromagnetic energy, may be reflected by objects with high conductive properties, like metal and conductive water. Alternately, the microwaves may be absorbed in various degrees by low dielectric or insulating mediums, such as plastics, glass, paper, many powders and food stuffs and other solids. Microwave sensors may be deployed and implemented in a wide variety of techniques. In use, two basic signal processing techniques may be applied, wherein each offering corresponding advantages. Firstly, the Pulsed or Time-Domain Reflectometry (TDR) facilitating measuring time of flight divided by the speed of light, similar to ultrasonic level sensors, and secondly the Doppler systems facilitating employing Frequency-Modulated Continuous-Wave (FMCW) techniques. Like ultrasonic level sensors, microwave sensors may be executed at various frequencies ranging from a minimum of approximately 1 GHz to a maximum of approximately 30 GHz. As a general rule, the higher the frequency, the more accurate may be the performance, and thus the more may be the cost. Microwave sensors may be executed based on a non-contact technique or guided. The first technique may be performed by monitoring a microwave signal that is transmitted through free space (including vacuum) and reflected back, or may be executed as a “radar on a wire” technique, generally known as Guided Wave Radar or Guided Microwave Radar. In the latter technique, performance generally improves in powders and low dielectric media that are not good reflectors of electromagnetic energy transmitted through a void, as in case of non-contact microwave sensors. However, with the guided technique the same mechanical constraints may exist that cause problems for the aforementioned capacitance (RF) techniques by having a probe in the vessel. In some scenarios involving deployment of non contact microwave-based radar sensors, the sensors may be capable of seeing through low conductivity microwave-transparent (non-conductive) glass/plastic windows or vessel walls through which the microwave beam may be passed, and measuring a microwave reflective (conductive) liquid inside, in the same way as to use a plastic bowl in a microwave oven. The non contact microwave-based radar sensors may also remain largely unaffected by high temperature, pressure, vacuum or vibration. As the non contact microwave-based radar sensors do not require physical contact with the process material, thus the transmitter/receiver may be mounted a safe distance above or away from the process, even with an antenna extension of several meters to reduce temperature, yet the non contact microwave-based radar sensors may still respond to the changes in level or distance, for instance the non contact microwave-based radar sensors may be ideal for measurement of molten metal products at over 1200° C. Microwave transmitters may also offer the same key advantage as in case of ultrasonic sensors owing to the presence of a microprocessor to process the signal, provision of numerous monitoring, controls, communications, setup and diagnostic capabilities independent of changing density, viscosity and electrical properties. Additionally, the microwave transmitters may solve some of the application limitations of ultrasonic sensors, for instance operability in high pressure and vacuum, high temperatures, dust, temperature and vapor layers. Guided Wave Radars may be capable of successfully measuring in narrow confined spaces, as the guide element ensures correct transmission to and from the measured liquid. Applications, such as inside stilling tubes or external bridles or cages, offer an excellent alternative to float or displacement devices, as they may remove any moving parts or linkages and may remain unaffected by density changes or build up. The Guided Wave Radars may also be excellent with very low microwave reflectivity products like liquid gases, such as Liquefied Natural Gas (LNG), Liquefied Petroleum Gas (LPG), Ammonia, which are stored at low temperatures/high pressures, although care needs to be taken on sealing arrangements and hazardous area approvals. On bulk solids and powders, Guided Wave Radars (GWRs) may offer a great alternative to radar or ultrasonic sensors. However, some care may need to be taken over cable wear and roof loading by the product movement. Still however, one perceived major disadvantage of the microwave or radar techniques for level monitoring may be the relatively high price of such sensors and complex set up.

In some embodiments involving deployment of sensors for continuous level measurement of liquids, magnetostrictive level sensors may be deployed, which may be similar to float type sensors in that a permanent magnet sealed inside a float travels up and down a stem in which a magnetostrictive wire is sealed. Ideal for high-accuracy, continuous level measurement of a wide variety of liquids in storage and shipping containers, the magnetostrictive level sensors may require the proper choice of float based on the specific gravity of the liquid. In some scenarios involving choice of float and stem materials for magnetostrictive level sensors, the same guidelines described for magnetic and mechanical float level sensors may apply. In use, the magnetostrictive level and position devices may charge the magnetostrictive wire with electrical current, in the event that field intersects with the magnetic field of the float thereby leading to generation of a mechanical twist or pulse. The generated pulse may travel back down the wire at the speed of sound, like ultrasound or radar, thereby facilitating measuring the distance by time of flight from the pulse to return pulse registry. The time of flight corresponds to the distance from the sensor detecting the return pulse. Owing to the accuracy of the magnetostrictive technique, the technique may be best-suited for “custody-transfer” applications. The magnetostrictive technique may be permitted by an agency of weights and measures for conducting commercial transactions. The magnetostrictive technique may be frequently applied on magnetic sight gauges. In some scenarios involving deployment of the magnetostrictive technique on magnetic sight gauges, the magnet may be installed in a float that travels inside a gauge glass or tube. The magnet operates on the sensor, which is mounted externally on the gauge. Boilers and other high temperature or pressure applications take advantage of this performance quality.

In some embodiments involving deployment of sensors for continuous level measurement of liquids, the resistive chain level sensors, which are similar to the magnetic float level sensors in that a permanent magnet sealed inside a float moves up and down a stem in which closely spaced switches and resistors are sealed, may be deployed. In use, in the event that the switches are closed, the resistance is summed and converted to current or voltage signals that are proportional to the level of the liquid. In some scenarios involving the use of float and stem materials, identification and selection of the float and stem materials depends on the liquid in terms of chemical compatibility, specific gravity and other factors affecting buoyancy. The resistive chain level sensors may work well for liquid level measurements in marine, chemical processing, pharmaceuticals, food processing, waste treatment, and other applications. In some scenarios involving successful selection or choice of two floats, the resistive chain level sensors may also be used to monitor for the presence of an interface between two immiscible liquids whose specific gravities are more than 0.6, but differ by as little as 0.1 units.

In some embodiments involving deployment of sensors for continuous level measurement of liquids, the resistive chain level sensors, the magnetoresistance float level sensors similar to the float level sensors, however wherein a permanent magnet pair is sealed inside the float arm pivot, may be deployed. In operation, upon movement of the float in the upward direction, the motion and location are transmitted as the angular position of the magnetic field. The magnetoresistance float level sensors may be highly accurate down to 0.02 degrees of motion. In use, the field compass location provides a physical location of the float position. In some scenarios involving finalization of float and stem materials, the identification and selection of the float and stem materials depends on the liquid in terms of chemical compatibility, specific gravity and other factors affecting buoyancy of the float. In use, the electronic monitoring system thereof may not come in contact with the fluid, and thus may be considered useful from the perspective of intrinsic safety or explosion proof. The magnetoresistance float level sensors may work well for liquid level measurements in marine, vehicle, aviation, chemical processing, pharmaceuticals, food processing, waste treatment, and other applications. Due to the presence of a microprocessor combined with low power consumption capability, the magnetoresistance float level sensors may also be capable of performing or facilitating serial communication from and to other computing devices, thereby rendering the magnetoresistance float level sensors and the corresponding technique used best-suited for adjusting calibration and filtering of the sensor signal.

In some embodiments involving deployment of sensors for continuous level measurement of liquids, the hydrostatic pressure level sensors submersible or externally mounted pressure sensors, suitable for measuring the level of corrosive liquids in deep tanks or water in reservoirs may be deployed. In use, use of chemically compatible materials is important to assure proper performance of the hydrostatic pressure level sensors submersible or externally mounted pressure sensors. For example, the hydrostatic pressure level sensors submersible or externally mounted pressure sensors are commercially available from 10 mbar to 1000 bar. In use, the hydrostatic pressure level sensors submersible or externally mounted pressure sensors may sense increasing pressure with depth, and because the specific gravities of liquids are different, the sensor must be properly calibrated for each application. In addition, in use large variations in temperature may cause changes in specific gravity that should be accounted for, upon conversion of the pressure to level. The hydrostatic pressure level sensors submersible or externally mounted pressure sensors may be designed to keep the diaphragm free of contamination or build-up, thus ensuring proper operation and accurate hydrostatic pressure level measurements. In some scenarios involving use in open air applications, in the event that the hydrostatic pressure level sensor submersible or externally mounted pressure sensor cannot be mounted to the bottom of the tank or pipe thereof, a special version of the hydrostatic pressure level sensor may be suspended from a cable into the tank to the bottom point that is to be measured. Specifically, the hydrostatic pressure level sensor must be specially designed to seal the electronics from the liquid environment. In some scenarios involving use in tanks with a small head pressure, for instance less than 100 INWC, it is very important to vent the back of the hydrostatic pressure level sensor gauge to atmospheric pressure. Otherwise, normal changes in barometric pressure may introduce large error in the sensor output signal.

In some embodiments involving deployment of sensors for continuous level measurement of liquids, the air bubbler system, using a tube with an opening below the surface of the liquid level, may be deployed. In use, a fixed flow of air may be passed through the tube. Pressure in the tube may be proportional to the depth (and density) of the liquid over the outlet of the tube. Specifically, the air bubbler systems contain no moving parts, making the same suitable for measuring the level of sewage, drainage water, sewage sludge, night soil, or water with large quantities of suspended solids. More specifically, the only part of the sensor that contacts the liquid is a bubble tube, which is chemically compatible with the material whose level is to be measured. Since the point of measurement has no electrical components, the technique may serve as a good choice for classified “Hazardous Areas”. In use, the control portion of the system may be located safely away, with the pneumatic plumbing isolating the hazardous from the safe area. The air bubbler systems may serve as a good choice for open tanks at atmospheric pressure and may be built so that high-pressure air is routed through a bypass valve to dislodge solids that may clog the bubble tube. The technique is inherently “self-cleaning”. It is highly recommended for liquid level measurement applications where ultrasonic, float or microwave techniques may prove undependable.

In some embodiments, dry material (powders) level sensors may be used to measure levels of solid, dry materials (powders). The aforementioned level measurements may be at least one of continuous and point values represented with various output options. Continuous level sensors are devices that measure level within a specified range and give output of a continuous reading of level, whereas point level sensors devices mark a specific level, generally used as high alarm or switch. In some scenarios, multiple point sensors may be integrated together to give a stepped version of continuous level. In some scenarios involving deployment and implementation of the dry material level sensors and powder level sensors, the measuring range is probably the most important specification to examine. In addition, field adjustability may be a nice feature to have for tuning, upon installation.

In some embodiments, the dry material level sensors and powder level sensors may be at least one of plain sensors with some sort of electrical output and more sophisticated instruments that have displays and sometimes computer output options. In some scenarios depending on the needs of the applications, level sensors may be mounted a few different ways, for instance the level sensors may be mounted on the top, bottom or sides of the containers holding the substances to be measured. Further, among the technologies for measuring level are air bubblers, capacitive or RF admittance, differential pressure, electrical conductivity or resistivity, mechanical or magnetic floats, optical units, pressure membrane, radar or microwave, radio frequency, rotation paddle, ultrasonic or sonic and vibration or tuning fork technologies. In some scenarios, analog outputs from dry material level sensing devices and powder level sensing devices may be current or voltage signals. However, in some scenarios, the analog outputs from dry material level sensing devices and powder level sensing devices may be also be a pulse or frequency. Still however, in some scenarios, another option may be an alarm output or a change in state of switches. Computer signal outputs that are possible are usually serial or parallel.

In some embodiments involving managing levels of dry materials (powders) in smart portable chargeable canisters, the transducer and transceiver unit may comprise a dry material (powder) level sensor possessing apposite specifications, in accordance with the principles of the present invention. For example, and in no way limiting the scope of the invention, the dry material (powder) level sensor may possesses the following specifications, namely 1) device classification as at least one of sensor-only and sensor system; 2) level measurement type may be at least one of continuous level, point Level and multi-point levels; 3) instrument (sensor system) only options, for instance (A) instrument display options may be at least one of (i) non-electrical visual (audio output), (ii) analog meter (indicator), (iii) digital readouts and (iv) Video Display Terminal (VDT) and (B) instrument user interface options may be at least one of (i) analog front panel, (ii) digital front panel and (iii) computer controllable; 4) features, for instance (A) sanitary applications rated, for instance 3-A sanitary standards, (B) liquids with suspended solids (slurries) handling capability, (C) built in alarm indicator, (D) programmable, (E) recorder/totalizer functions and (F) controller functions; 5) measuring range, for instance (A) number of switch points and (B) allowable sensor over-range; 6) output options may be at least one of analog voltage, analog current and frequency (modulated frequency); 7) field adjustable performance, for instance field adjustable measurement ranges; 8) process operating conditions, for instance (A) maximum operating pressure, (B) material temperature range and (C) material density; 9) meter technology, for instance at least one of (A) differential pressure sensors, (B) most preferably ultrasonic/sonic, radar/microwave, (C) optical, (D) pressure membrane, (E) electrical conductivity or resistance, (F) capacitive/RF admittance, (G) air bubbler, (H) mechanical/magnetic floats, (I) rotation paddle, (J) Radio Frequency (RF), (K) vibrating/tuning fork method and (L) other; 10) communication interface options may be at least one of (A) serial interface, (B) parallel interface and (C) other; 11) mounting options may be at least one of (A) most preferably side or horizontal mount, (B) top mount and (C) bottom mount.

In some embodiments, design and implementation of the smart portable chargeable gastronorm containers thereby facilitating measuring levels of substances contained therein is disclosed, in accordance with the principles of the present invention.

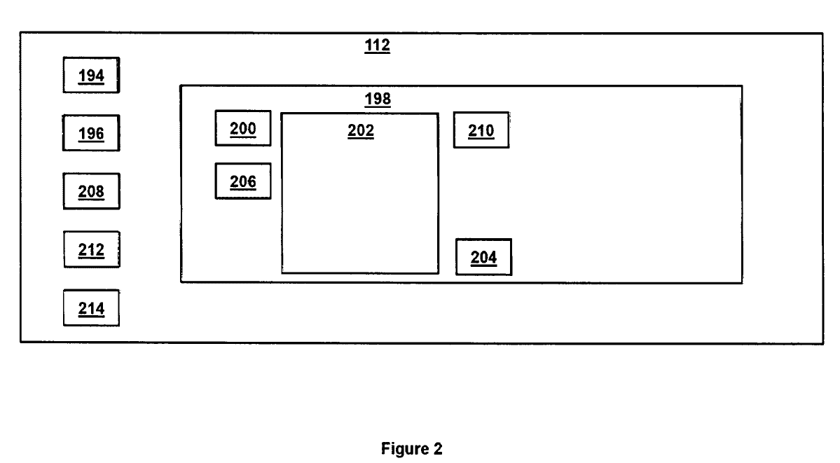

FIG. 2 depicts a block diagrammatic representation of the smart portable chargeable gastronorm containers 112, of FIGS. 1A-C, facilitating measuring levels of substances contained therein, according to one or more embodiments.

Each of the smart portable chargeable gastronorm containers 112 may comprise a transducer transceiver unit 194, at least one of a wiredly and wirelessly rechargeable, replaceable battery unit 196 and a third microcomputer unit 198.

The third microcomputer unit 198 may comprise a third microprocessor subunit 200, third memory subunit 202, a third Input/Output (I/O) subunit 204 and third support circuits 206, respectively. In addition, the smart portable chargeable gastronorm container 112 may comprise a third wireless communication transceiver subunit 208. Further, in addition, the smart portable chargeable gastronorm container 112 may optionally comprise a third display subunit 210. In some embodiments, the smart portable chargeable gastronorm container 112 may comprise a third GPS subunit 212 and a third GPRS subunit 214.

In some embodiments, for example, and in no way limiting the scope of the invention, the transducer transceiver unit 194 may comprise an ultrasonic transducer and transceiver circuitry. In some embodiments, for example, and in no way limiting the scope of the invention, the ultrasonic transducer transceiver circuitry 194 may comprise a non-contact ultrasonic sensor 216 (not shown here explicitly). Specifically, the non-contact ultrasonic sensor 216 may comprise an analog signal processor 218, a microprocessor, for instance the third microprocessor subunit 200, one or more Binary Coded Decimal (BCD) range switches 220 and an output driver circuit 222 (all not shown here explicitly). In operation, the third microprocessor subunit 200 may generate the gate signal and pulses and may direct the same to the ultrasonic sensor 216 via the analog signal processor 218 (not shown here explicitly). Upon reception of the generated pulses, the sensor 216 may transmit a beam of ultrasonic waves to the surface of the fluid. Upon transmission, the sensor 216 may receive the reflected echoes from the fluid surface and may send the same back to the third microprocessor subunit 200. The third microprocessor subunit 200 may keep on receiving echoes of sound waves and may perform calculations to determine distance between the sensor and the fluid surface, and hence detect the fluid level.

In some embodiments, the ultrasonic transducer transceiver circuitry 194 may comprise an ultrasonic transducer receiver sub-circuitry 224, ultrasonic transducer transmitter sub-circuitry 226, and a combination thereof, for instance the ultrasonic transducer transceiver (all not shown here explicitly).

Specifically, in operation, the ultrasonic transducer transceiver circuitry 194 may facilitate conversion of ultrasound (or ultrasonic) waves to electrical signals, or vice-versa, and transmission as well as reception of the same. In some scenarios involving reception and sensing of at least one of ultrasonic and electrical signals, the ultrasonic transducer receiver sub-circuitry 224 may facilitate reception of the at least one of ultrasonic and electrical signals and conversion from the source (or input) signals to corresponding destination (or output) signals, i.e. conversion from the ultrasonic to electrical signals, or vice-versa. In some scenarios involving sensing and transmission of at least one of ultrasonic and electrical signals, the ultrasonic transducer transmitter sub-circuitry 226 may facilitate conversion from the source (or input) signals to corresponding destination (or output) signals, i.e. conversion from the ultrasonic to electrical signals, or vice-versa and transmission of the at least one of ultrasonic and electrical signals.

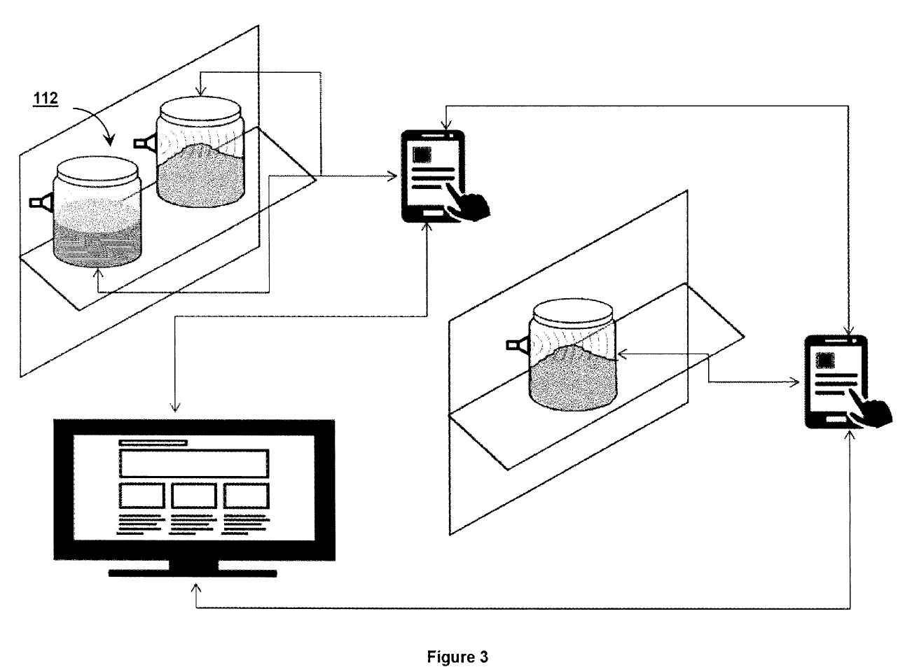

FIG. 3 depicts a pictorial representation of the smart portable chargeable gastronorm containers 112, of FIGS. 1A-C and 2 in use, according to one or more embodiments.

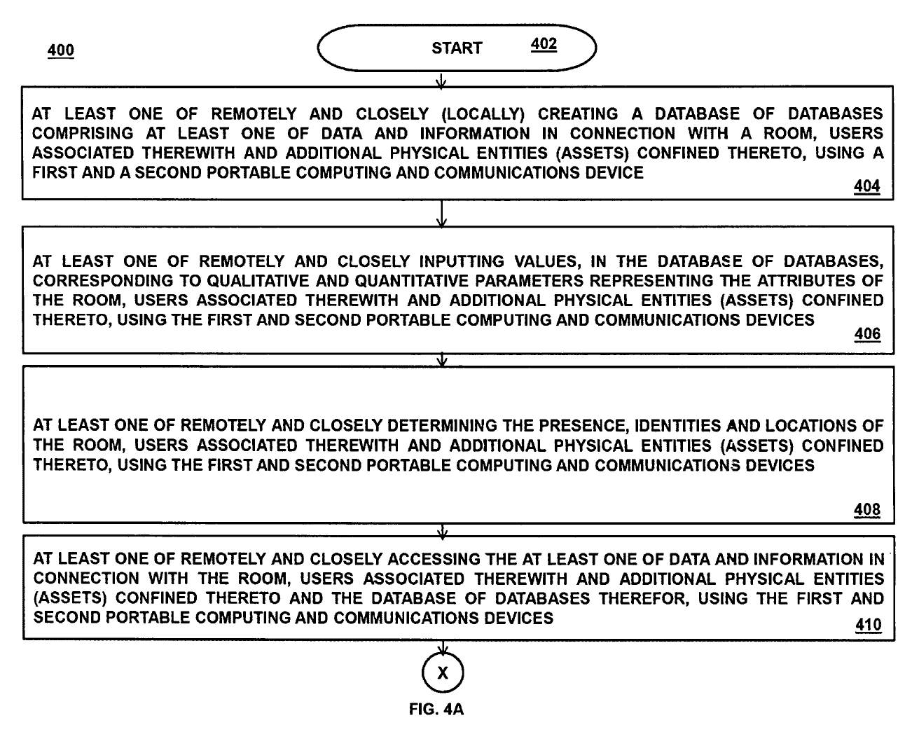

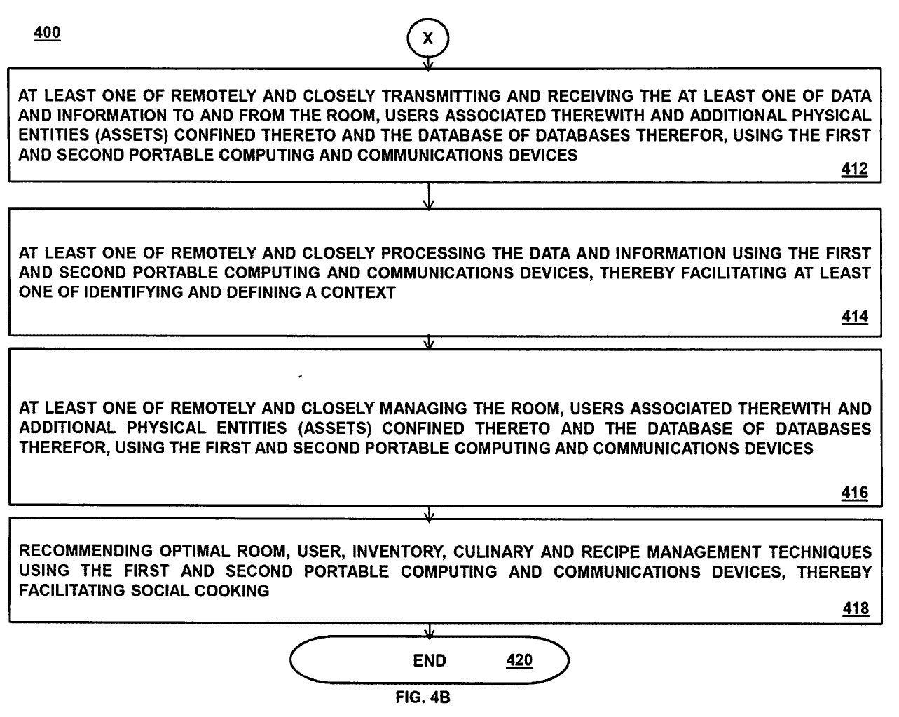

FIGS. 4A-B depict a flow diagram in connection with the method for facilitating enhancing smart automation management of a shared residential or commercial room, according to one or more embodiments. The method 400 starts at step 402 and proceeds to step 404. At step 404, the method 400 may comprise, or facilitate, at least one of remotely and closely (locally) creating a database of databases comprising at least one of data and information in connection with the shared residential or commercial room, users associated therewith and additional physical entities (assets) confined thereto, using a first and a second portable computing and communications device. At step 406, the method 400 may comprise, or facilitate, at least one of remotely and closely inputting values, in the database of databases, corresponding to qualitative and quantitative parameters representing the attributes of the shared residential or commercial room, users associated therewith and additional physical entities (assets) confined thereto, using the first and second portable computing and communications devices. At step 408, the method 400 may comprise, or facilitate, at least one of remotely and closely determining the presence, identities and locations of the shared residential or commercial room, users associated therewith and additional physical entities (assets) confined thereto, using the first and second portable computing and communications devices. At step 410, the method 400 may comprise, or facilitate, at least one of remotely and closely accessing the at least one of data and information in connection with the shared residential or commercial room, users associated therewith and additional physical entities (assets) confined thereto and the database of databases therefor, using the first and second portable computing and communications devices. At step 412, the method 400 may comprise, or facilitate, at least one of remotely and closely transmitting and receiving the at least one of data and information to and from the shared residential or commercial rooms, users associated therewith and additional physical entities (assets) confined thereto and the database of databases therefor, using the first and second portable computing and communications devices. At step 414, the method 400 may comprise, or facilitate, at least one of remotely and closely processing the data and information using the first and second portable computing and communications devices, thereby facilitating at least one of identifying and defining a context. At step 416, the method 400 may comprise, or facilitate, at least one of remotely and closely managing the shared residential or commercial room, users associated therewith and additional physical entities (assets) confined thereto and the database of databases therefor, using the first and second portable computing and communications devices.

At step 418, the method 400 may comprise, or facilitate, recommending optimal room, user, inventory, culinary and recipe management techniques using the first and second portable computing and communications devices, thereby facilitating social cooking.

The method 400 ends at step 420.

In some embodiments, deployment and implementation of a Three-Dimensional (3-D) scene management module, and 3-D objects thereof, for use in managing 3-D scenes (views) of the shared residential, commercial, private and utility-cum-storage rooms, and the images (visuals) or videos of 3-D objects thereof, are disclosed, in accordance with the principles of the present invention. Specifically, the 3-D scene management module may be based on the concepts of at least one of 3-D data acquisition and reconstruction, 3-D modeling, 3-D mapping, 3-D object recognition, 3-D interaction, 3-D content retrieval, and the rest, thereby facilitating imaging 3-D scenes (views) and 3-D objects thereof, reconstructing 3-D computer models from the captured 3-D scenes (views) and 3-D objects thereof, mapping the captured 3-D scenes (views), 3-D objects thereof, and relationships therebetween, detecting or recognizing the mapped 3-D scenes (views), 3-D objects thereof, interacting with the mapped 3-D scenes (views), 3-D objects thereof, selectively accessing the mapped 3-D scenes (views), 3-D objects thereof and managing, i.e. navigating, traversing and manipulating, the selectively accessed 3-D scenes (views), 3-D objects thereof via retrieval of at least one of semantic content (metadata) tags therefor, in accordance with the principles of the present invention.

In some embodiments, for example, and in no way limiting the scope of the invention, the 3-D scene management module may be a distributed application software, wherein a distributed server-side 3-D scene management application may be at least one of hosted and installed, and thus running on the home server of the smart HAN, whereas a distributed 3-D scene management client-side application may be at least one of hosted and installed, and thus running on the at least one of portable and wearable computing and communications devices.

Referring to FIG. 1B, the first memory subunit 174, of the first microcomputer unit 170 of the home server 114, may comprise the distributed server-side 3-D scene management application 199A (not shown here explicitly), whereas the second memory subunit 144, of second microcomputer unit 140 of the at least one of portable and wearable computing and communications devices, may comprise the distributed server-side 3-D scene management 199B (not shown here explicitly), respectively.

In some embodiments, the at least one of portable and wearable computing and communications devices may be at least custom-designed using, and retrofitted with, at least one of 3-D scanner and 3-D camera. For example, and in no way limiting the scope of the invention, the 3-D scanner may be at least one of contact 3-D scanner, non-contact active scanner, time-of-flight 3-D laser scanner, triangulation based 3-D laser scanner, hand-held laser scanner, structured-light 3-D scanner and modulated light 3-D scanner, whereas the 3-D camera may be at least one of a range and stereo camera.

The at least one of 3-D scanner and 3-D camera may facilitate 3-D data acquisition and reconstruction via generation of 3-D or spatiotemporal models based on acquired data from a sensor. For example, and in no way limiting the scope of the invention, the 3-D data acquisition and reconstruction techniques and theories may work with most or all sensor types including optical, acoustic, laser scanning, radar, thermal, seismic. More specifically, the acquisition may occur from a multitude of methods including 2-D images, acquired sensor data and on site sensors.

In some scenarios involving acquisition from 2-D images, the 3-D data acquisition and object reconstruction may be performed using stereo image pairs. Specifically, stereo photogrammetry or photogrammetry based on a block of overlapped images may serve as the primary approach for 3-D mapping and object reconstruction using 2-D images. In addition, close-range photogrammetry may use cameras or digital cameras to capture the close-look images of objects and reconstruct the same using the same theory as the aerial photogrammetry.

In operation, upon acquisition of the data, the acquired (and sometimes already processed) data from images or sensors may be subjected to reconstruction. In some scenarios, the reconstruction may be performed in the same software program used for 3-D data acquisition. However, in some alternative scenarios, the 3-D data may be exported and imported into another software program for further refining, and/or to add additional data, for instance the GPS-location data.

In some embodiments involving deployment and implementation of 3-D reconstruction, the process of capturing the shape and appearance of real objects may be accomplished by at least one of active and passive methods. Specifically, the active methods of 3-D reconstruction actively interfere with the reconstructed object, at least one of mechanically and radiometrically. For instance, a simple example of a mechanical method may be use of a depth gauge to measure a distance to a rotating object put on a turntable, whereas radiometric methods may emit radiance towards the object and measure the reflected part. On the other hand, the passive methods of 3-D reconstruction may not interfere with the reconstructed object. The passive methods of 3-D reconstruction may only use a sensor to measure the radiance reflected or emitted by the surface of the object to infer the 3-D structure of the object. For instance, the sensor is may be an image sensor in a camera sensitive to visible light and the input to the method is a set of digital images (one, two or more) or video. The aforementioned method is image-based reconstruction, and wherein the output is a 3-D model.

In some embodiments involving deployment and implementation of 3-D modeling, the process of developing a mathematical representation of any three-dimensional surface of an object may be accomplished via specialized software. The product may be called a 3-D model. The 3-D model may be displayed as a Two-Dimensional (2-D) image through a process called 3-D rendering or used in a computer simulation of physical phenomena.

In some embodiments involving deployment and implementation of 3-D mapping, 3-D views of objects may be created on computer screens. For instance, 3-D mapping may be used in modern computer programs to provide a life-like view of a place or thing on a map. In some scenarios, portable Global Position Satellite (GPS) devices may use 3-D mapping technology to provide automated directions. Specifically, the portable GPS devices may have small screens to display a 3-D view of roads and maps.

In some involving deployment and implementation of object recognition, object recognition may facilitate finding and identifying objects in an image or video sequence. For example, object recognition may be accomplished via implementation of one or more approaches, namely 1) approaches based on CAD-like object models, for instance edge detection, primal sketch, Marr, Mohan and Nevatia, Lowe and Olivier Faugeras; 2) appearance-based methods, for instance edge matching, divide-and-conquer search, Greyscale matching, gradient matching, histograms of receptive field responses, and large modelbases; 3) feature-based methods, for instance, interpretation trees, hypothesize and test, pose consistency, pose clustering, invariance, geometric hashing, Scale-Invariant Feature Transform (SIFT) and Speeded Up Robust Features (SURF) and 4) genetic algorithm. In addition, one or more other approaches, such as 3-D cues, biologically inspired object recognition, Artificial Neural Networks (ANN) and deep learning, context, explicit and implicit 3-D object models, fast indexing, global scene representations, gradient histograms, grammars, intraclass transfer learning, leveraging internet data, reflectance, shading, template matching, texture, topic models, unsupervised learning, window-based detection, deformable part model, and Bingham distribution, may be implemented to accomplish object recognition.

In some scenarios involving 3-D single-object recognition in computer vision, 3D single-object recognition comprises recognizing and determining the pose of user-chosen 3-D object in a photograph or range scan. In use, for instance, an exemplary object to be recognized may be presented to a vision system in a controlled environment. Upon an arbitrary input, such as a video stream, the previously presented object may be located. The 3-D single-object recognition in computer vision may be performed at least one of off-line and real-time. The algorithms for -D single-object recognition in computer vision may be specialized for locating a single pre-identified object, and may be contrasted with algorithms, which operate on general classes of objects, such as face recognition systems or 3D generic object recognition.

In some involving deployment and implementation of 3-D interaction in computing, 3-D interaction facilitates human-machine interaction, whereby users may be able to move and perform interactions in 3-D space. Both human and machine process information where the physical position of elements in the 3-D space is relevant. Specifically, the 3-D space used for interaction may be at least one of a real physical space, virtual space representation simulated in a computer, and a combination thereof. In some scenarios involving usage of the real space for data input, humans perform actions or give commands to the machine using an input device that detects the 3-D position of the human action. In some scenarios involving usage of the real space for data output, the simulated 3-D virtual scene is projected onto the real environment through one output device or a combination thereof.

In use, 3-D user interfaces may facilitate communication between users and systems or machines. In some embodiments, the 3-D interfaces may include media for 3-D representation of system state, and media for 3-D user input or manipulation. Since using 3-D representations may not be enough to create 3-D interaction, the users must have a way of performing actions in 3-D, as well. To that effect, special input and output devices may be used to support 3-D interactions. Some, such as the 3-D mouse, have been developed based on existing devices for 2-D interaction. 3-D interaction techniques may facilitate implementing different types of task in 3-D space. Thus, the 3-D interaction techniques may be classified according to the tasks supported namely selection and manipulation, navigation, system control and symbolic input.

In some involving deployment and implementation of 3-D content retrieval, 3-D content retrieval may facilitate browsing, searching and retrieving 3-D digital contents, for instance computer-aided designs, molecular biology models, and cultural heritage 3D scenes, and the rest, from a large database of digital images using 3-D search engine. In operation, 3-D content retrieval comprises adding description text to 3-D content files, such as the content file name, link text, and web page title so that related 3-D content may be found through text retrieval. Specifically, in operation, in order to avoid inefficiency owing to manual annotation of 3-D files, the 3-D files are subjected to automated annotation based on a unified standard to create text descriptions for 3-D contents. For example, and in no way limiting the scope of the invention, shape matching retrieval techniques based on comparison and contrast of similarities and dissimilarities between one or more 3-D models may be utilized for content retrieval. In addition, the 3-D content retrieval methods or techniques may be based on deriving a high level description, for instance a skeleton, followed by finding matching results, known as skeleton modeling. Still, in addition, the 3-D content retrieval methods or techniques may be based on computing a feature vector based on statistics. Yet other 3-D content retrieval methods or techniques are based on 2-D projection method.

Reiterating again, in some embodiments, methods and systems for facilitating locating, positioning and tracking the smart portable chargeable gastronorm containers located in the kitchen and confined to, or positioned, on one or more kitchen shelves thereof, and systems therefor are disclosed, in accordance with the principles of the present invention. Specifically, each of the at least one of smart portable and wearable chargeable computing and communications devices may comprise proprietary application software for facilitating locating, positioning and tracking the smart portable chargeable canisters or gastronorms. For example, and in no way limiting the scope of the invention, the methods and systems of the present invention may facilitate locating, positioning and tracking the smart portable chargeable gastronorm canisters located in the kitchen and confined to, or positioned, on one or more kitchen shelves thereof via implementation of at least one of Wi-Fi-based Positioning System (WPS or WiPS/WFPS), Indoor Positioning System (IPS), Local Positioning System (LPS), Real-Time Locating System (RTLS) and Hybrid Positioning System (HPS), in accordance with the principles of the present invention.

In use, an explicit 3-D coordinate system may be defined by users for each of the at least one of shared residential, commercial, private and utility-cum-storage rooms. Depending on the direction and order of the coordinate axes the user-defined 3-D coordinate system may be at least one of a right-handed and left-handed system. Specifically, in use, the exact positions or locations of the smart portable chargeable gastronorm containers and smart portable chargeable home appliances, for instance small home appliances including, but not limited to, heating, food processing and cooking appliances, such as food preparation appliances, ovens, stoves, and other major home appliances including, but not limited to, freezers, coolers, dishwashers, water heaters, utility meters, such as smart electricity, gas, water and heat meters, may be defined via ordered tuples (triple, treble or triplet) comprising a sequence or ordered list of Three (3) elements, namely X, Y and Z coordinates, respectively. In use, a given fixed point of intersection, or fixed point of reference for the geometry of the surrounding space, of the X-, Y- and Z-axes in the user-defined 3-D coordinate system may be selected as origin.

In use, the entire space encompassed by the at least one of shared residential, commercial, private and utility-cum-storage rooms may be represented by a 3-D solid matrix or grid. For example, and in no way limiting the scope of the invention, the geometrical and dimensional specifications of the at least one of shared residential, commercial, private and utility-cum-storage rooms may be analogous to, or represent, at least one of a cube, cuboid and the like. As a consequence, in use, the 3-D solid matrix or grid may be at least one of a cubical and cuboidal matrix. Each of the at least one of unit cubes and cuboids constituting the at least one of cubical and cuboidal matrix may facilitate in defining the 3-D coordinates of the smart devices in the at least one of shared residential, commercial, private and utility-cum-storage rooms.

Further, in use, advantageously from the standpoint of accuracy and reliability of data or information in connection with location, an external user may be capable of remotely locating or positioning large objects, for instance a given smart home and the smart HAN therefor, in the corresponding smart BANs, and the corresponding NANs. Upon successfully locating, the given smart home and the smart HAN therefor the user may be able to access the at least one of Wi-Fi-based Positioning System (WPS or WiPS/WFPS), Indoor Positioning System (IPS), Local Positioning System (LPS), Real-Time Locating System (RTLS) and Hybrid Positioning System (HPS), thereby facilitating remote local positioning of relatively small objects, for instance major home appliances including, but not limited to, freezers, coolers, dishwashers, water heaters, utility meters, such as smart electricity, gas, water and heat meters. In some scenarios involving major home appliances statically positioned over a given period of time, at least one of the located major home appliances may be considered as a reference point for purposes of positioning or locating smart devices in at least one of proximity and vicinity of the at least one of the located major home appliances serving as a reference point, and confined in the at least one of shared residential, commercial, private and utility-cum-storage rooms.

In some embodiments, deployment of the at least one of smart and dummy containers in at least one of entertainment and patron bars is disclosed, in accordance with the principles of the present invention. Specifically, the at least one of smart and dummy containers may be correspondingly at least one of custom-designed and retrofit designed, in accordance with the principles of the present invention, for deployment in the at least one of entertainment and patron bars. Advantageously, the at least one of custom-designed smart and retrofit designed dummy containers may facilitate partially automatic overall management of the same, and the contents therein, in at least one of entertainment and patron bar environments. In some scenarios involving users (or customers or patrons) in the at least one of entertainment and patron bar environments, the at least one of custom-designed smart and retrofit designed dummy containers may facilitate partially automatic refilling of the same with drinks or beverages. In use, each of the at least one of custom-designed smart and retrofit designed dummy containers may be set aside (or kept back), and thus be positioned or located on a table by users.

In operation, the table service cum setting departments of the at least one of entertainment and patron bars may have access to a virtual (or simulated) map, thereby facilitating the concerned staff of the table service cum setting departments to readily manage the tables, customers or patrons seated thereon, and the at least one of custom-designed smart and retrofit designed dummy containers or dishware. Specifically, in use, the concerned staff of the table service cum setting departments may be able to readily access, retrieve, view, update, insert, delete at least one of textual and graphical (or pictorial) data or information in connection with the current status of the tables, customers or patrons seated thereon, and the at least one of custom-designed smart and retrofit designed dummy containers or dishware, and thus serve and manage billing therefor in a partially automated fashion and more conveniently. In some scenarios in the event that the current level of contents in the at least one custom-designed smart and retrofit designed dummy containers or dishware is below a minimum desired or predefined level, the at least one custom-designed smart and retrofit designed dummy containers or dishware may transmit an alert signal or message or request to notify the concerned staff of the table service cum setting departments to refill the contents thereof. In some scenarios, the at least one custom-designed smart and retrofit designed dummy containers or dishware may be capable of capturing one or more quantitative and qualitative parameters in connection with the status of the tables, customers or patrons seated thereon, and the contents of the at least one custom-designed smart and retrofit designed dummy containers or dishware, for instance the required or desired serving temperature of the contents, the number of times of filling, the current level, the average amount or volume or weight of the contents filled per filling, the current or provisional bill, i.e. price per litre or grams*amount or volume or weight in litres or grams consumed, and the rest.

Advantageously, in some embodiments involving deployment of the at least one custom-designed smart and retrofit designed dummy containers or dishware in hospitals or other emergency patient Point-Of-Care (POC) sites, in the event that the current level or amount or weight or volume of the contents is below a threshold minimum, the at least one custom-designed smart and retrofit designed dummy containers or dishware may transmit an alert signal or message or request to the concerned staff (nurse or attendant) of the concerned medical department to at least one of replace and refill the contents thereof.

Still advantageously, in some embodiments involving deployment of the at least one custom-designed smart and retrofit designed dummy containers or dishware in at least one of shared residential, commercial, private and utility-cum-storage rooms, such as kitchens, the at least one custom-designed smart and retrofit designed dummy containers or dishware may automatically generate and transmit an alert signal or message or request to the linked grocery store or vendor so as to supply required items, and the corresponding amounts or volumes or weights thereof.

Still more advantageously, in some embodiments involving deployment of the at least one custom-designed smart and retrofit designed dummy containers or dishware in at least one of shared residential, commercial, private and utility-cum-storage rooms, the proprietary app loaded or installed, and running on at least one of portable and wearable computing and communications device owned and operated by users may be able to receive, and thus display unbiased (brand-independent) or biased (brand-dependent or specific or related brands) targeted advertisements regarding edible or consumable products based on the recommendations made by the proprietary app subject to the consumption or buying or purchasing or usage history and behaviour of the users, the automatically generated alert signals or messages or requests in connection with the resupply of the contents depending on the monthly inventory of grocery items.

### Example Computer System

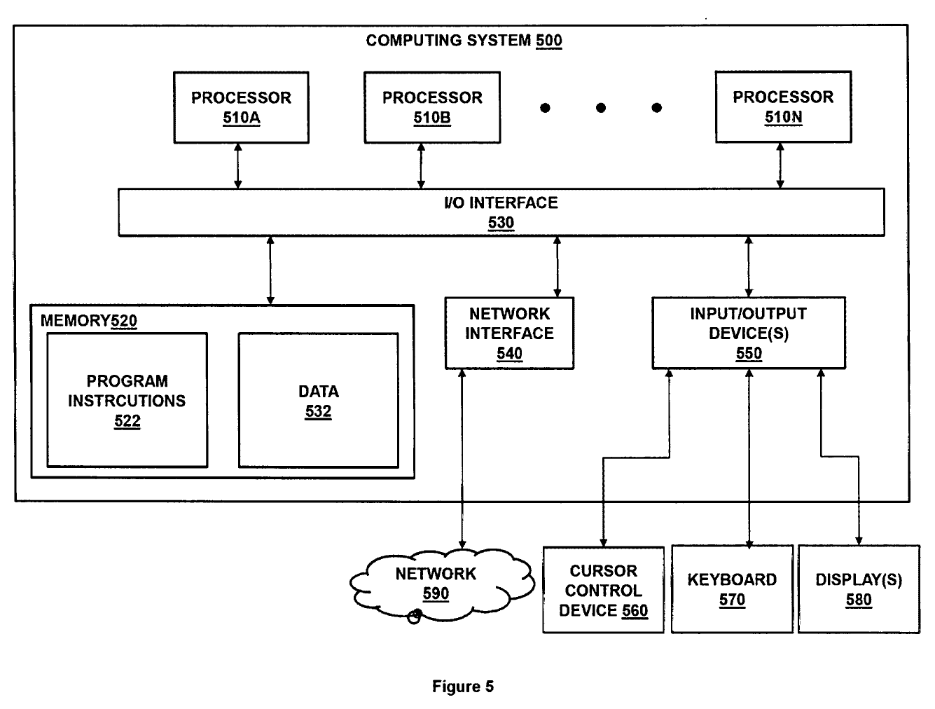

FIG. 5 depicts a computer system that may be a computing device and may be utilized in various embodiments of the present invention. Various embodiments of the method and system for enhanced smart home automation management facilitating social cookery in a social cooking network, as described herein, may be executed on one or more computer systems, which may interact with various other devices. One such computer system is computer system 500 illustrated by FIG. 5, which may in various embodiments implement any of the elements or functionality illustrated in FIGS. 1A-C and 2-4. In various embodiments, computer system 500 may be configured to implement one or more methods described above. The computer system 500 may be used to implement any other system, device, element, functionality or method of the above-described embodiments. In the illustrated embodiments, computer system 500 may be configured to implement one or more methods as processor-executable executable program instructions 522 (e.g., program instructions executable by processor(s) 510A-N) in various embodiments. In the illustrated embodiment, computer system 500 includes one or more processors 510A-N coupled to a system memory 520 via an input/output (I/O) interface 530. The computer system 500 further includes a network interface 540 coupled to I/O interface 530, and one or more input/output devices 550, such as cursor control device 560, keyboard 570, and display(s) 580. In various embodiments, any of components may be utilized by the system to receive user input described above. In various embodiments, a user interface (e.g., user interface) may be generated and displayed on display 580. In some cases, it is contemplated that embodiments may be implemented using a single instance of computer system 500, while in other embodiments multiple such systems, or multiple nodes making up computer system 500, may be configured to host different portions or instances of various embodiments. For example, in one embodiment some elements may be implemented via one or more nodes of computer system 500 that are distinct from those nodes implementing other elements. In another example, multiple nodes may implement computer system 500 in a distributed manner. In different embodiments, computer system 500 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device. In various embodiments, computer system 500 may be a uniprocessor system including one processor 510, or a multiprocessor system including several processors 510 (e.g., two, four, eight, or another suitable number). Processors 510A-N may be any suitable processor capable of executing instructions. For example, in various embodiments processors 510 may be general-purpose or embedded processors implementing any of a variety of instruction set architectures (ISAs), such as the x96, POWERPC®, SPARC®, or MIPS® ISAs, or any other suitable ISA. In multiprocessor systems, each of processors 510A-N may commonly, but not necessarily, implement the same ISA. System memory 520 may be configured to store program instructions 522 and/or data 532 accessible by processor 510. In various embodiments, system memory 520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 520. In other embodiments, program instructions and/or data may be received, sent or stored upon different types of computer-accessible media or on similar media separate from system memory 520 or computer system 500. In one embodiment, I/O interface 530 may be configured to coordinate I/O traffic between processor 510, system memory 520, and any peripheral devices in the device, including network interface 540 or other peripheral interfaces, such as input/output devices 550. In some embodiments, I/O interface 530 may perform any necessary protocol, timing or other data transformations to convert data signals from one components (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components, such as a north bridge and a south bridge, for example. Also, in some embodiments some or all of the functionality of I/O interface 530, such as an interface to system memory 520, may be incorporated directly into processor 510. Network interface 540 may be configured to allow data to be exchanged between computer system 500 and other devices attached to a network (e.g., network 590), such as one or more external systems or between nodes of computer system 500. In various embodiments, network 590 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 540 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol. Input/output devices 550 may, in some embodiments, include one or more display terminals, keyboards, keypads, touchpads, scanning devices, voice or optical recognition devices, or any other devices suitable for entering or accessing data by one or more computer systems 500. Multiple input/output devices 550 may be present in computer system 500 or may be distributed on various nodes of computer system 500. In some embodiments, similar input/output devices may be separate from computer system 500 and may interact with one or more nodes of computer system 500 through a wired or wireless connection, such as over network interface 540. Those skilled in the art will appreciate that computer system 500 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 500 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available. Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 500 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc. The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for facilitating enhancing smart automation management of a room, the method comprising:
at least one of remotely and closely (locally) creating a database of databases comprising at least one of data and information in connection with the room, users abiding therein and additional physical entities (assets) confined thereto, using a first and a second portable computing and communications device;
at least one of remotely and closely inputting values, in the database of databases, corresponding to qualitative and quantitative parameters representing the attributes of the room, users abiding therein and additional physical entities (assets) confined thereto, using the first and second portable computing and communications devices;
at least one of remotely and closely determining the presence, identities and locations of the room, users abiding therein and additional physical entities (assets) confined thereto, using the first and second portable computing and communications devices;
at least one of remotely and closely accessing the at least one of data and information in connection with the room, users abiding therein and additional physical entities (assets) confined thereto and the database of databases therefor, using the first and second portable computing and communications devices;
at least one of remotely and closely transmitting and receiving the at least one of data and information to and from the room, users abiding therein and additional physical entities (assets) confined thereto and the database of databases therefor, using the first and second portable computing and communications devices;
at least one of remotely and closely processing the data and information using the first and second portable computing and communications devices, thereby facilitating at least one of identifying and defining a context;
at least one of remotely and closely managing the room, users associated therewith and additional physical entities (assets) confined thereto and the database of databases therefor, using the first and second portable computing and communications devices; and
recommending optimal room, user, inventory, culinary and recipe management techniques using the first and second portable computing and communications devices, thereby facilitating social cooking.

2. The method of claim 1, wherein the room is at least one of a shared residential room, shared commercial room, shared public space, utility cum storage, private room, great house area, and the like, wherein tangible items subject to at least one of decay, destruction, dissipation, wastage and consumption may be stored in one or more containers.

3. The method of claim 1, wherein the users associated with the room are at least one of owners, family members, general public, customers, friends and social contacts thereof.

4. The method of claim 1, wherein the additional physical entities (assets) confined to the room are at least one of home appliances, such as at least one of major, small appliances and consumer electronics, computer appliances, utility meters, containers, furniture, and the like.

5. The method of claim 1, wherein the additional physical entities (assets) confined to the room are at least one of cooking, food processing and food preparation appliances.

6. The method of claim 4, wherein the containers are gastronorm containers and dishware.

7. The method of claim 1, the additional physical entities (assets) confined to the room are at least one of smart and non-smart, at least one of wiredly and wirelessly chargeable, and at least one of portable and fixed.

8. The method of claim 1, wherein the first and second portable computing and communication devices are smart, at least one of wiredly and wirelessly chargeable, and at least one of portable, wearable and fixed.

9. The method of claim 1, wherein the at least one of remotely and closely managing the room, users associated therewith and additional physical entities (assets) confined thereto, using the first and second portable computing and communications devices comprises at least one of remotely and closely measuring the at least one of levels and amounts of substances contained in the gastronorm containers.

10. The method of claim 9, wherein the at least one of levels and amounts of substances contained in the gastronorm containers are measured using a transducer transceiver circuitry.

11. The method of claim 10, wherein the transducer transceiver circuitry is at least one of side (horizontally), bottom and top (vertically)-mounted with respect to the gastronorm containers.

12. The method of claim 6, wherein the gastronorm containers are at least one of custom-designed smart and retrofit designed dummy containers.

13. The method of claim 12, wherein the at least one of custom-designed smart and retrofit designed dummy containers may facilitate fully automatic measurement of the at least one of level, amount, weight and volume of at least one of edible and consumable contents, and partially automatic refilling with at least one of edible and consumable contents such that the contents may be in at least one of dry powder, liquid, semi-solid, semi-liquid, viscous, granular, aerated liquid, emulsion, aerated solids and gels.

14. The method of claim 13, wherein the at least one of custom-designed smart and retrofit designed dummy containers may facilitate capturing one or more quantitative and qualitative parameters in connection with the status of the furniture, consumers seated thereon, and the contents of the at least one custom-designed smart and retrofit designed dummy containers (dishware).

15. The method of claim 14, wherein the one or more quantitative and qualitative parameters in connection with the status of the furniture, consumers seated thereon, and the contents of the at least one custom-designed smart and retrofit designed dummy containers (dishware) may comprise the required (desired) serving temperature of the contents, the number of times of filling, the current level, the at least one of average amount, volume and weight of the contents filled per filling, the current (provisional) bill for the at least one of amount, volume, weight and level consumed.

16. The method of claim 13, wherein a proprietary application loaded (installed), and running on the at least one of portable and wearable computing and communications device owned and operated by users may be able to receive, and thus display at least one of unbiased and biased targeted advertisements regarding edible products based on the recommendations generated by the proprietary application subject to the at least one of consumption, ordering, buying, purchasing, usage history and behaviour of the users, the automatically generated alert signals in connection with the resupply of the contents depending on monthly inventories of grocery items.

17. The method of claim 1, wherein the information in connection with the at least one of custom-designed smart objects and retrofit designed non-smart objects, the ambience thereof, the location therefor and the virtual map of the at least one of area and space to which the at least one of custom-designed smart objects and retrofit designed non-smart objects are confined may facilitate at least one of human-to-human, object-to-object, human-to-object interactions, and combinations thereof.

18. The method 10, wherein the transducer transceiver circuitry may be an ultrasonic transducer transceiver circuitry.

19. The method of claim 12, wherein the gastronorm containers are at least one of custom-designed smart and retrofit designed dummy containers may be capable of adaptively and dynamically measuring and storing the at least one of current level, amount, weight and volume of substance stored in the containers.

20. The method of claim 19, wherein the gastronorm containers are at least one of custom-designed smart and retrofit designed dummy containers may be capable of adaptively and dynamically reporting the stored and measured the at least one of current level, amount, weight and volume of substance stored in the containers to the first and second portable computing and communication devices via transmitting at least one of a message and alert signal.
